(19) United States
(12) Patent Application Publication
(10) Pub. No.: US 2016/0132161 A1
(43) Pub. Date: May 12, 2016

(54) LOCATION OR CROWD SOURCE BASED GAMING METHOD AND APPARATUS

(71) Applicant: StoryCloud, Inc., San Diego, CA (US)

(72) Inventors: Kenneth J. KALB, Solana Beach, CA (US); Michael W. TRACY, Solana Beach, CA (US); Barry SHAPIRA, Solana Beach, CA (US); Christina LIAO, San Diego, CA (US)

(21) Appl. No.: 14/537,856

(22) Filed: Nov. 10, 2014

(51) Int. Cl. G06F 3/048; A63F 13/30; A63F 13/54; H04L 29/08; A63F 13/216

(52) U.S. Cl. CPC G06F 3/048; H04L 67/18; A63F 13/216; A63F 13/54; A63F 13/30

(57) ABSTRACT

Some aspects of the invention relate to a method receives a first location associated with a mobile device. The method determines that the first location is within a range of a second location associated with associated with an activity. The method provides instructions for participating in the activity to the device.

### BACKGROUND

1. Field

The present disclosure relates generally to social gaming, and more specifically to participating in location or crowd based interactive activity.

2. Background

Social networks provide users with the capability of interacting with known or pre-selected users, or friends. Gaming networks (or social gaming) provide similar capabilities. Users of a gaming network may compete against preselected users or groups. Unfortunately, users of the gaming network may only compete against those pre-selected users or in some cases, completely random users. It is impossible to target unknown users based on certain demographics or other criteria. Moreover, it is difficult to link up users of a service in a fun and interactive manner.

As mobile technology has advanced, advertisers continue to seek out new and unique ways to target and entice certain known and unknown users. Although many social networking services are available on mobile devices, it is still necessary for users to be “friends” with a particular advertiser to receive advertisements or incentives. Moreover, it is also difficult for such advertisers to utilize additional information to produce ads or incentives that target specific demographics.

Additionally, online gaming (or interactive activities) has been used as a mechanism to entice internet users to learn more about a product. Although such games may be provided to internet users as ads that are based on a user's behavior, these games do not necessarily entice users to visit a particular location such as a department store. Therefore, it is difficult to provide location-based games that are targeted to a wide variety of users and entices such users to consume associated products.

Moreover, crowdsourcing is typically used in an online community to solicit contributions from others. However, crowd source contributors typically have a vested interest in the topic for which information is being shared or consumed. At present time, crowdsourcing for content does not rely on fun interactive activities that entice users of a service to produce and consume content related to a given topic.

### SUMMARY

Some aspects of the invention relate to a method that receives a first location associated with a mobile device. The method determines that the first location is within a range of a second location associated with associated with an activity. The method provides instructions for participating in the activity to the device.

Some aspects of the invention relate to a computer program product having a machine-readable medium comprising instructions executable to: receive a first location associated with a mobile device, determine that the first location is within a range of a second location associated with associated with an activity, and provide data for participating in the activity to the device.

Some aspects of the invention relate to a system having at least one processor configured to: receive a first location associated with a mobile device, determine that the first location is within a range of a second location associated with associated with an activity, and provide instructions for participating in the activity to the device.\

Some aspects of the invention relate to a method that generates a themed flow. The method receives several users to include in the flow. The method receives a type of content from a device of a particular one of the several users associated with the flow. Upon receiving the content, the users from which content was not received are removed from the flow.

It is understood that other aspects of processes and apparatuses will become readily apparent to those skilled in the art from the following detailed description, wherein various aspects of apparatuses and methods are shown and described by way of illustration. As understood by one of ordinary skill in the art, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatuses will now be presented in the detailed description by way of example, and not by way of limitation, with reference to the accompanying drawings, wherein:

FIG. 1 illustrates an exemplary device that is capable of participating in a location based interactive activity.

FIG. 2 illustrates an exemplary device participating in a location based interactive activity provided by the interactive activity service.

FIG. 3 illustrates an exemplary device having captured an image 320 of a QR code.

FIG. 4 illustrates an exemplary device that displays a new set of instructions for participating in the location based interactive activity.

FIG. 5 conceptually illustrates a process for providing a location based interactivity activity to a device requesting to participate in an interactive activity.

FIG. 6 illustrates an exemplary device that has completed a location based interactive activity without receiving any explicit user interaction.

FIG. 7 illustrates an exemplary device that accesses the interactive activity service to provide a display of different interactivity activities and associated locations.

FIG. 8 conceptually illustrates a process for providing instructions for participating in a location based interactive activity to a device that satisfies predefined criteria.

FIG. 9 illustrates an exemplary display of a device that is communicatively connected to the location based interactive activity service.

FIG. 10 illustrates an example display of a device for setting different parameters or criteria defining which users of the location based interactive activity service are able to access the interactive activity.

FIG. 11 conceptually illustrates a process for providing a location based interactive activity to the interactive activity service.

FIG. 12 illustrates several users' interactions with several devices that are participating in the second embodiment of the interactive activity service.

FIG. 13 conceptually illustrates a process for performing a crowd sourced interactive activity according to a second embodiment of the interactive activity service.

FIG. 14 illustrates an exemplary diagram of a user device's capabilities within the crowd sourced interactive activity service.

FIG. 15 illustrates several rounds of an exemplary flow.

FIG. 16 conceptually illustrates a process for performing a crowd source interactive activity according to the second embodiment of the interactive activity service.

FIG. 17 illustrates an exemplary flow similar to that of FIG. 15

FIG. 18 conceptually illustrates a process for performing a crowd sourced flow of the second embodiment of the interactive activity service that enables a previously excluded user device to re-enter the flow.

FIG. 19 illustrates an exemplary state diagram associated with the second embodiment of the interactive activity service.

FIG. 20 illustrates an exemplary user's interaction with a crowd sourced interactive activity on a device by performing spectator interactions with the interactive activity service.

FIG. 21 illustrates an exemplary reorganization of a flow based on the received up and down votes.

FIG. 22 conceptually illustrates a process for performing a flow reorganization as part of the second embodiment of the interactive activity service.

FIG. 23 illustrates an exemplary configuration of a interactive activity server, including location based and crowd sourced interactive activities.

FIG. 24 illustrates an exemplary electronic system that may implement the interactive activity service.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The word “exemplary” is used herein to mean serving as an example, instance, or illustration. Any embodiment described herein as “exemplary” is not necessarily to be construed as preferred or advantageous over other embodiments. Likewise, the term “aspect” or “embodiment” of an apparatus, method or article of manufacture does not require that all embodiments of the invention include the described components, structure, features, functionality, processes, advantages, benefits, or modes of operation.

It will be further understood that the terms “comprises” and/or “comprising,” when used in this specification, specify the presence of stated features, steps, operations, elements, and/or components, but do not preclude the presence or addition of one or more other features, integers, steps, operations, elements, components, and/or groups thereof. The term “and/or” includes any and all combinations of one or more of the associated listed items.

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

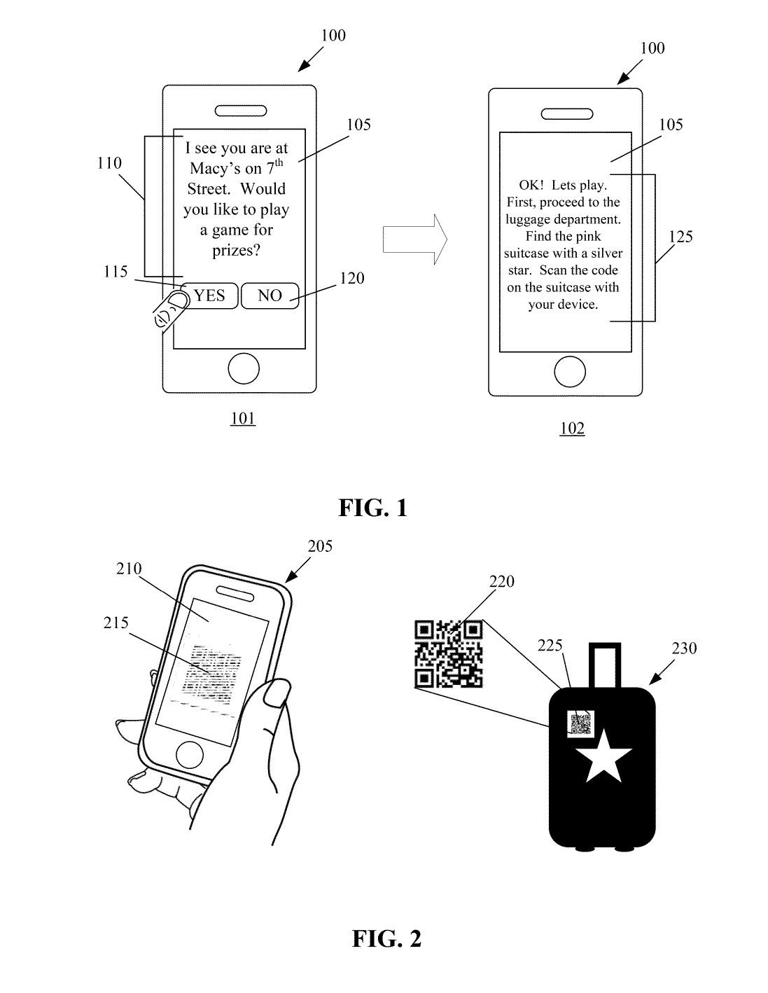

A first embodiment of the disclosure provide various processes and apparatuses for providing location based interactive services to devices that are communicatively connected to an interactive activity service or server. FIG. 1 illustrates an exemplary device 100 that is capable of participating in a location based interactive activity. The figure illustrates a user's interaction with the device 100 in two stages 101 and 102. The device 100 includes a display area 105. The display area 105 includes text 110 and selectable user interface (UI) objects 115. In this example, the UI objects 115 and 120 are buttons. However, other selectable UI objects commonly used for interacting with mobile devices may be used without limiting the functionality of the interactive activity service. For instance, the selectable UI objects may include radio buttons, text boxes, drop down menus, or any other UI object that is capable of being selected by user interaction.

The device 100 may be any communication device that is capable of communicating with the interactive activity service. Such device may include smartphones, laptop computers, tablet devices, and/or media players. The first stage 101 illustrates the device 100 after the device 100 may have connected to the interactive activity service.

In the first stage 101, the interactive activity service may recognize that the device 100 is located within a predefined geographic range. For instance, the interactive activity service may receive a notification that the device 100 is located inside a particular department store that has set up a location based interactive activity for users of the interactive activity service. In such instances, the device 100 may be connected to a Global Positioning Service (GPS), which provides geographic position data to the device 100. The device 100 may then relay the geographic information to the interactive activity service, which may then send instructions to the device 100 to display a message such as the one illustrated in display area 105. Optionally, display area 105 may display selectable UI objects 115 and 120, which upon receiving an interaction from a user may cause new information to display in display area 105.

The second stage 102 illustrates an exemplary display of display area 105 after a user interacts with one of the selectable UI objects 115 and/or 120 of the first stage 101. For instance, the display area 105 may have received a selection of UI object 115, which causes the display illustrated in the second stage 102.

The second stage includes text 125 in display area 105. In some aspects of the interactive activity service, the displayed text may include instructions useful for the user to engage in the location based interactive activity. In such aspects, the text 125 may instruct the user to perform a particular activity using his/her device. For instance, the location based interactive activity may be a scavenger hunt type of activity. In such instances, the text 125 may provide a clue about how to find the next item in the scavenger hunt. In other instances, the text 125 may simply provide a code for obtaining a type of reward, such as a discount.

FIG. 2 illustrates an exemplary device 205 participating in a location based interactive activity provided by the interactive activity service. The device 205 of may be similar to the device 100 illustrated in FIG. 1. In some aspects of the interactive activity service, the device 205 may have received instructions, such as the instructions illustrated in the second stage 102 of FIG. 1 to participate in a location based interactive activity such as a scavenger hunt. The device 205 includes a display area 210, and an image 215. As shown, the device 205 may be taking a photograph of a code 225 located on a particular item 230. Code 220 illustrates an exploded view of the code located on the item 230. In some aspects of the interactive activity service, the code may be a Quick Response (QR) code, or a barcode of the time. Conjunctively or alternative, the interactive activity service may include software that is capable of recognizing and identifying certain items or shapes. The interactivity activity service may then transmit data associated with the identified item or shape. In the example illustrated in FIG. 2 the device 205 may transmit the image of the QR code 215 to the interactive activity service for verification.

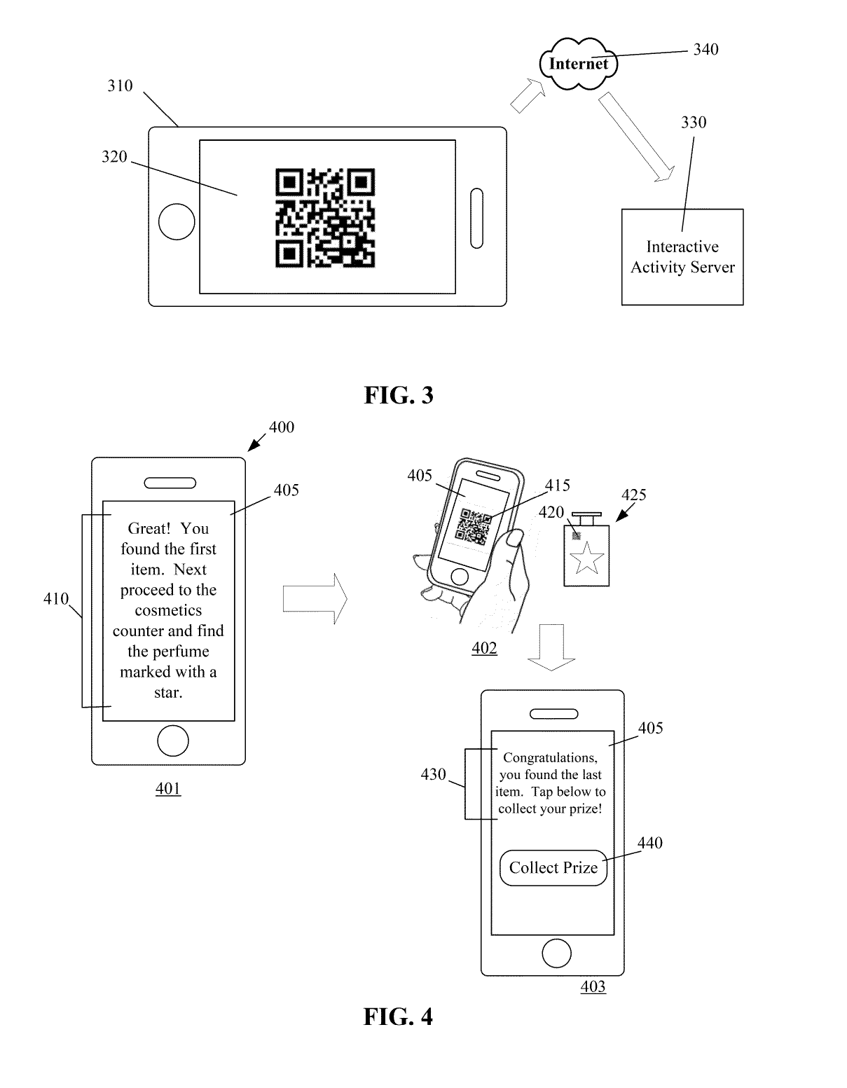

FIG. 3 illustrates an exemplary device 310 having captured an image 320 of a QR code such as the QR code illustrated with respect to FIG. 2. As shown, the image 320 is ready to be transmitted to an external server 330. As shown. FIG. 3 includes a device such as the wireless device 310, the QR code image 320, an interactive activity server 330, and internet 340.

The QR code image 320 may be wirelessly transmitted over the internet 340 to the interactive activity server 330. Alternatively, the image may be converted to a data structure using scanning software comprised on the device 310 and the data structure may be transmitted over the internet 340. The location based interactive activity process performed by the interactive activity server will be described in greater detail below.

When the interactive activity server 330 determines that the received QR code completes at least a portion of the scavenger hunt activity, the interactive activity service may provide further instructions for the device 310 to display. Such instructions may assist the user of the device in completing the next task (or locating the next item) in the interactive activity. For instance, FIG. 4 illustrates an exemplary device 400 that displays a new set of instructions for participating in the location based interactive activity. In some aspects of the interactive activity service, device 400 is similar to device 100 described with respect to FIG. 1. FIG. 4 describes a user's interaction with the device 400 in three stages 401-403.

The device 400 includes a display area 405. In the first stage 401, the display area 405 displays text 410. The text 410 may be displayed after the interactive activity service has determined that the device has completed a location based activity. Such a determination may lead to the display area 405 displaying new instructions for participating in a new location based activity. Text 410 displays exemplary instructions that may be provided to the device for display by the interactive activity service. The second stage 402 is similar to the illustration of the device 200 participating in the interactive activity discussed with respect to FIG. 2. In the second stage 402, the device 400 is capturing an image 415 of a code 420 found on an item 425. As discussed in greater detail with respect to FIG. 3, the device 405 may then transmit the image 415 to the interactive activity service. The interactive activity service may then determine if the captured image completes the location based activity.

In the third stage 403, display area 405 is now displaying text 430 and selectable UI object 440. The text 430 may indicate that the location based activity was completed with the transmission of the image from the second stage 402. Thus, the third stage 403 may display text 430, which provides an indication to the user that the location based activity is complete. Optionally, the interactive activity service may provide a prize for completing at least one or more location based activities. Such a prize may be transmitted to the device 400 upon receiving a selection at the device 400 of selectable UI object 440. However, in some aspects of the interactive activity service, the prize may automatically display in display area 405 upon completion of a specific or set of tasks associated with the interactive activity.

As will be discussed in detail in the foregoing paragraphs, several different types of activities may be provided by the interactive activity service. The types of activities are not limited to the ones discussed with respect to FIGS. 1 and 2.

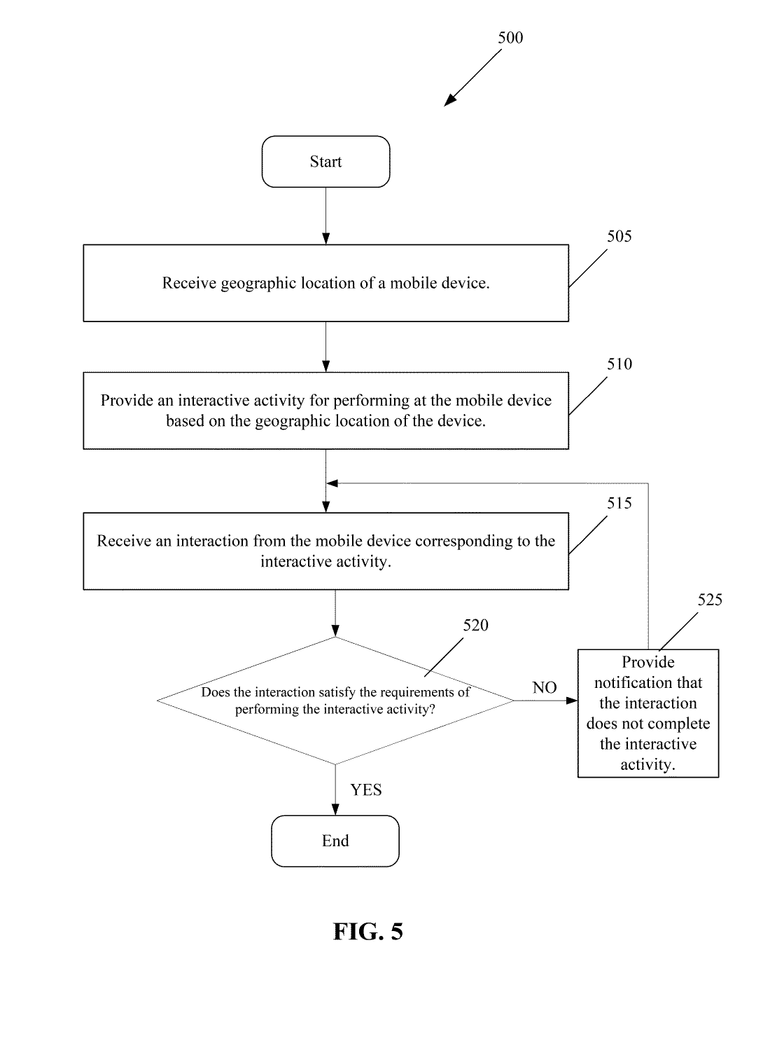

FIG. 5 conceptually illustrates a process 500 for providing a location based interactivity activity to a device requesting to participate in a location based interactive activity. The process 500 may be run on an interactive activity server such as interactive activity server 330 described with respect to FIG. 3. The process 500 may begin after a device has accessed the interactive activity service through a mobile device.

As shown, the process 500 receives (at 505) a geographic location of a mobile device. The process 500 provides (at 510) at least one interactive activity to be performed by the mobile device based on the geographic location of the device. As discussed in the foregoing, the geographic location may be determined by a GPS service built into the wireless device. The process 500 receives (at 515) an interaction from the mobile device corresponding to the interactive activity. The process 500 determines at 520 whether the received interaction satisfies the requirements of performing the location based interactive activity. When the received interaction does not satisfy the requirements of performing the location based interactive activity, the process 500 provides (at 525) a notification to the mobile device that the received interaction does not complete the location based interactive activity. The process 500 then returns to 515 to receive a new interaction corresponding to the interactive activity. When the received interaction satisfies the requirements of performing the location based interactive activity, the process 500 ends.

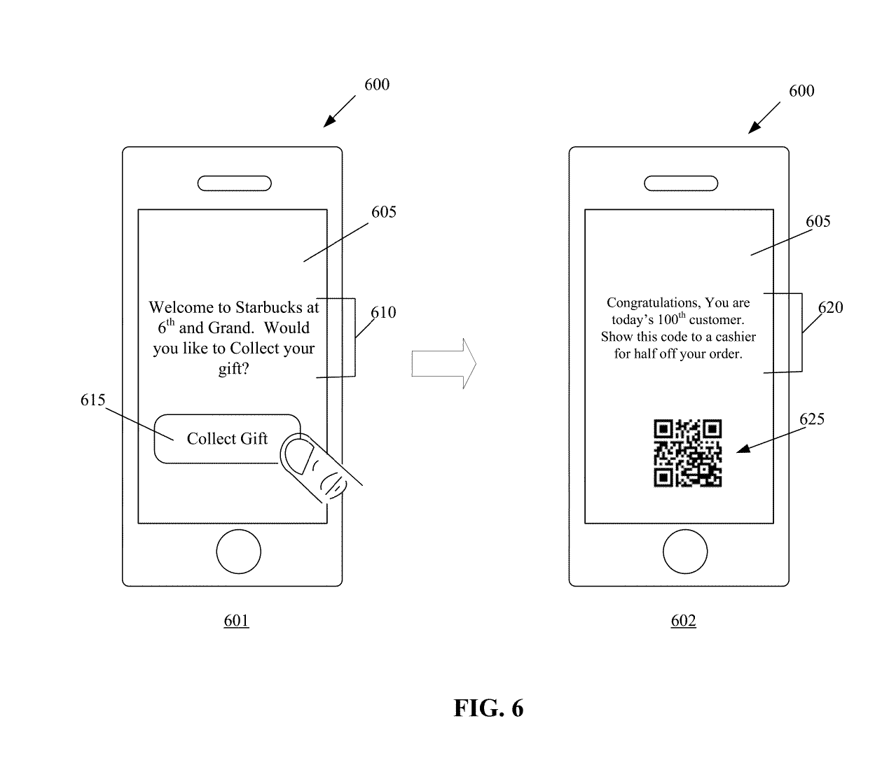

In some aspects of the interactive activity service, the location based interactive activity is only accessible by users who are within a specified range of the associated geographic location. In other aspects of the interactive activity service, the activity is only accessible to users within a specified range at a specified time. Additionally, some aspects of the interactive activity service may only enable access to mobile devices that have performed one or more particular behaviors or actions prior to engaging in the location based interactive activity. Additionally, some location based interactive activities may be completed without requiring any explicit interaction from the user. FIG. 6 illustrates an exemplary device 600 that has completed a location based interactive activity without receiving any explicit user interaction. FIG. 6 illustrates two stages 601 and 602 of a user's interaction with the device 600 connected to the interactive activity service.

Device 600 includes a display area 605, text 610, and selectable UI object 615. As shown in the first stage 601, the text 610 is displaying a message indicating that the device has completed a location based interactive activity. Although in this instance, a user has not performed an explicit interaction using device 600, the location based interactive activity server has recognized that the device 600 was likely carried by a user to a particular geographic location. In some aspects of the interactive activity service, the device 600 may periodically send GPS location information to the interactive activity service. Upon recognizing that the device is at a particular location, the interactive activity service may send a notification to the device. For instance, the interactive activity service may be configured to recognize every 100^{th} user to enter a particular store. In such instances, the interactive activity service may provide and transmit notification of a gift for every 100^{th} user that enters the particular store. The text 610 illustrates an exemplary notification.

Optionally, the display area 605 may also display a selectable UI object 615, which when selected displays a prize to be collected from participating in the activity. In the second stage, display area 605 now displays new text 620 and a code 625. In some aspects of the interactive activity service, the text 620 may provide information regarding the prize that the user has won. The code 625 may be a QR code that is used at the particular store to collect the gift provided to the device by the interactive activity service.

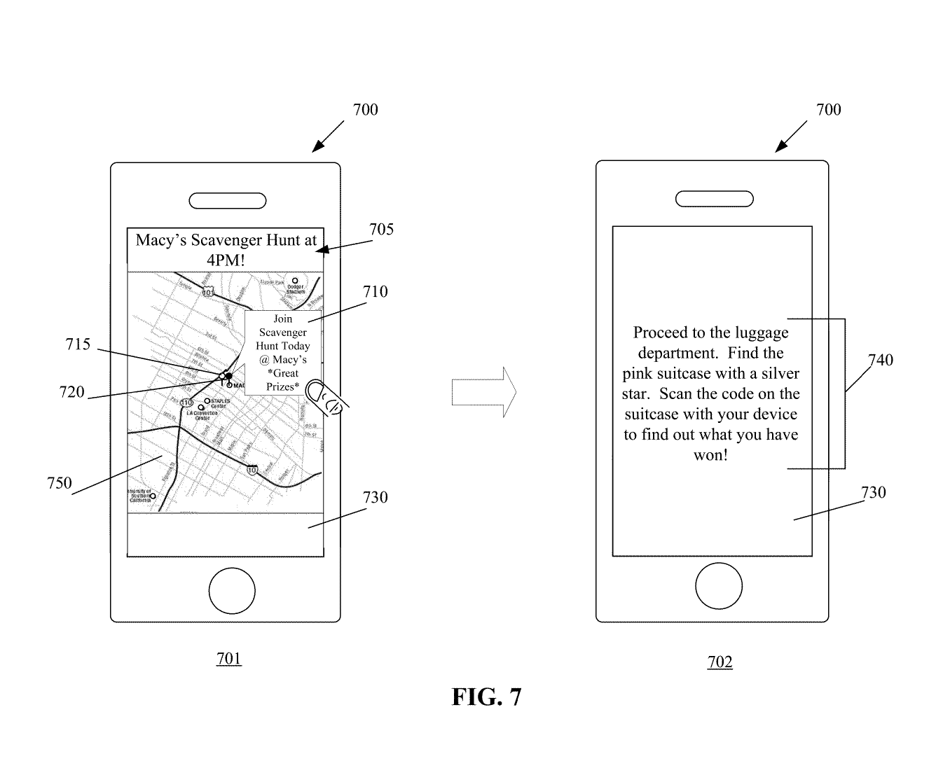

In some aspects of the interactive activity service, a device may be provided with visual indicators of location based interactive activities and associated locations for participating in the location based interactive activity. FIG. 7 illustrates an exemplary device 700 that accesses the interactive activity service to provide a display of different interactivity activities and associated locations. FIG. 7 illustrates two stages 701 and 702 of a user's interaction with the device 700.

Device 700 includes a display area 730. Display area 730 includes activity text information 705, visual indicators 715 and 720, selectable UI object 710, map 750 and text 740. In the first stage 701, the map 750 is displayed in the display area 730. On the map, the visual indicators 715 and 720 are displayed at specific locations. The visual indicators 715 and 720 are associated with interactive activities that can be accessed when the device is in or around the geographic location pinpointed by the visual indicators on the map 730. As shown in the first stage 701, visual indicator 715 has received an interaction from a user. Such an interaction may cause the interactive text 710 and the information text 705 to display in the display area 730.

As illustrated in the first stage 701, the display area 730 may display an array of location based interactive activities that are associated with a geographic range, such as the geographic range displayed by the map 750. In some aspects of the interactive activity service, the map 750 may be scaled by receiving a gestural action from a user. Additionally, visual indicators 715 and 720 may have different appearances. Such different appearances may indicate whether an activity is open to the device 700 or the device 700 is excluded from the activity. Devices may be excluded from different activities for a variety of reasons. For instance, a device may not be within the geographic range for participating in the activity, the activity may only be available for a specified period of time, and the current time is outside of that time period, or the activity may require certain behavioral patterns from the device prior to participation in the activity. In some aspects of the interactive activity service, upon selection of a visual indicator associated with an unavailable activity, the device may display the requirements for participating in the location based activity.

In this exemplary illustration, the appearance of visual indicator 715 may indicate that the activity associated with the visual indicator 715 is currently unavailable to the device, while the appearance of visual indicator 720 is currently available to the user. Therefore, receiving a user interaction associated with visual indicator 715 and/or a user interaction associated with interactive text 710 may cause the device 700 to display information about the location based interactive activity associated with visual indicator 715. Additionally, in some aspects of the interactive activity service, the interactive activity text information 705 may display information about the closest and/or next temporally available activity within the range of the map display 750.

The second stage 702 illustrates display area 730 after the device 700 has received an interaction to participate in an available location based interactive activity. As illustrated in display area 730, the device displays text 740 that may instruct the user of the device about how to start and/or complete the location based interactive activity.

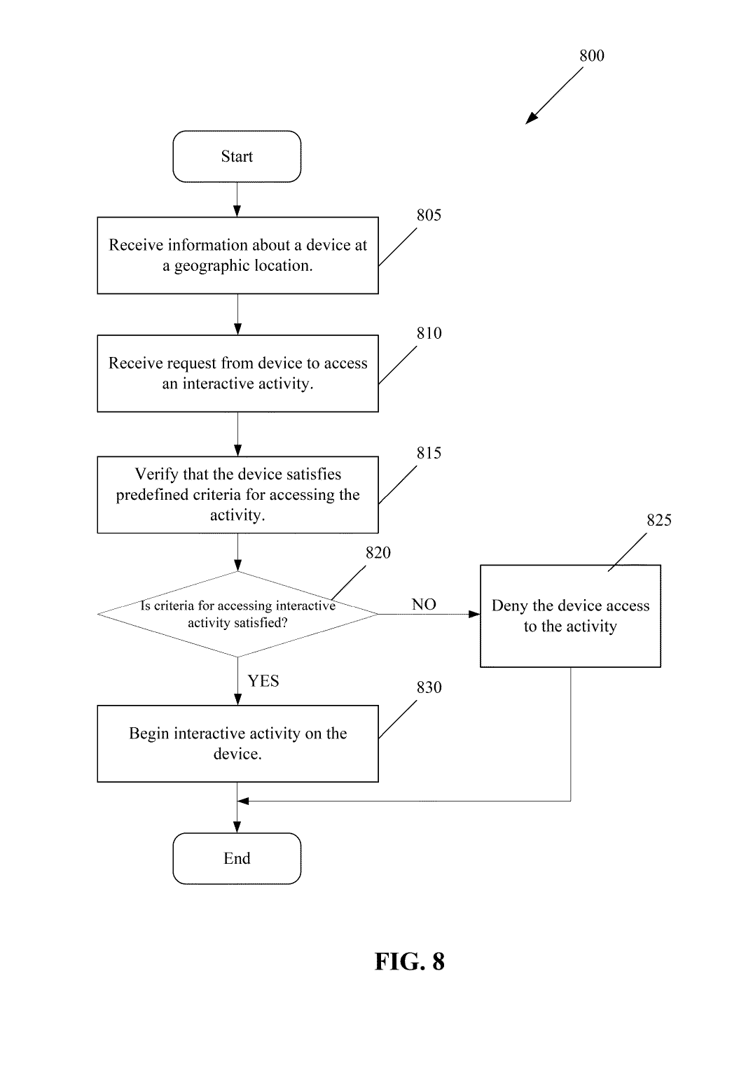

FIG. 8 conceptually illustrates a process 800 for providing instructions for participating in a location based interactive activity to a device that satisfies predefined criteria. The process 800 may be performed, for example by the interactive activity server 330. The process 800 may begin after a user has logged into the interactive activity service from a device such as a mobile device or any other device capable of accessing the internet.

As shown, the process 800 receives (at 805) information about a device at a geographic location. For instance, the process 800 may receive information about a device that is at a geographic location that is near a location associated with a particular interactive activity.

The process 800 receives (at 810) a request from the device to access a location based interactive activity. For instance, the device may attempt to access an interactive activity associated with a location that is near the location of the device. This particular interactive activity may have been posted to the interactive activity service along with a set of criteria which will be discussed in the foregoing sections along with the process of posting a location based interactive activity to the interactive activity service. In such instances, the interactive activity service will need to first verify that the mobile device satisfies the criteria specified when the location based interactive activity was posted.

At 815, the process 800 verifies the device satisfies the predefined criteria for accessing the interactive activity. In some aspects of the interactive activity service, when the device first registers with the interactive activity service, demographic information about the user of the mobile device may be provided to the interactive activity service. In such aspects, the interactive activity service may analyze the criteria associated with the interactive activity that the device wishes to access and determine if it the demographic information associated with the device fits the criteria.

However, the process 800 is not limited to only demographic information. Other information could also be considered in verifying that the device satisfies the criteria for accessing the location based interactive activity. Such information may include the number of the times that the location based interactive activity has been accessed. For example, if the location based interactive activity has been accessed more than a defined threshold number of times, the interactive activity service may determine that the device does not satisfy the criteria for accessing the location based interactive activity. Other criteria may include telecommunications providers, proximity of the device to the location associated with the interactive activity, and device manufacturer. Further criteria may include the criteria discussed in the foregoing such as timing and behavioral patterns.

The process 800 determines (at 820) whether the criteria for accessing the location based interactive activity is satisfied. When the process 800 determines that the criteria for accessing the location based interactive activity has been satisfied, the process 800 provides (at 830) the instructions for starting and/or completing the location based interactive activity to the device. When the process 800 determines that the criteria for accessing the location based interactive activity has not been satisfied, the process 800 denies (at 825) the device access to the location based interactive activity. As discussed above, access to the location based interactive activity on the interactive activity service may be temporarily available. Once access to the interactive activity has been provided or denied, the process 800 ends.

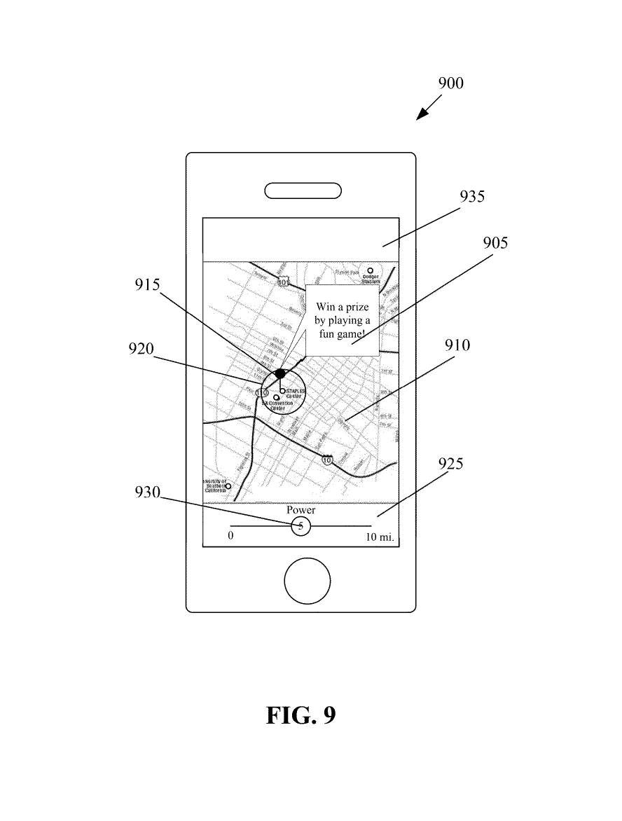

FIGS. 9-11 will now discuss the process of posting location based interactive activities to the interactive activity service and defining how the location based interactive activity may be accessed. FIG. 9 illustrates an exemplary display of a device 900 that is communicatively connected to the interactive activity service. The device display includes UI object 905, map display 910, interactive activity location indicator 915, radius indicator 920, display region 925, and UI object 930. The map display 910 shows a map of a region. The interactive activity location indicator 915 represents an interactive activity that is associated with a location on the map pinpointed by the position of the interactive activity location indicator 915 on the map display 910. The UI object 905 may display a description of or information about the location based interactive activity associated with the interactive activity location indicator. The radius indicator 920 is a circular indicator centered on the interactive activity location indicator 915. The radius indicator 920, in connection with the map display 910, represents a geographic region where users of the interactive activity service may access the interactive activity associated with the interactivity location indicator 915.

The device 900 also includes a UI object 930 in the display region 925. The UI object 930 of some aspects of the interactive activity service may be a slidable object 930. In some aspects of the interactive activity service, the slidable object 930 moves in response to a gestural action such as a touch and drag motion in a horizontal direction. The slidable object 930 controls the size of the access radius defined by the radius indicator 920. For instance, in this example, the access radius is defined at a size of 5 miles. As the slidable object 930 moves in a horizontal direction to the left or right, the access radius decreases or increases in size. The slidable object may be positioned on a scroll bar having a maximum and a minimum radius size. In this example, the minimum radius size is 0 miles and the maximum radius size is 10 miles. However, any minimum and maximum radius sizes may be utilized.

The device 900 may be used when the device is or is not at the location indicated by interactive activity location indicator 915. For instance, a user may wish to post an interactive activity that encourages users to visit a particular location. Additionally, the interactive activity service may provide the capability of broadcasting that a particular location based interactive activity will be accessible to users of the interactive activity service who are at a particular location at a particular time. For instance, the interactive activity service may announce to user devices that from 3-5 PM on Sunday, a free gift card will be available for any who visit a specific department store and complete an interactive activity. Such a broadcast may be confined geographically to only those devices that are within a specified distance from a location of the specified department store, while devices outside of the specified distance or timeframe may be excluded from the broadcast. Conversely, such a broadcast may be distributed to all users of the interactive activity service. Configuring broadcast messages will be discussed in greater detail in the following figure.

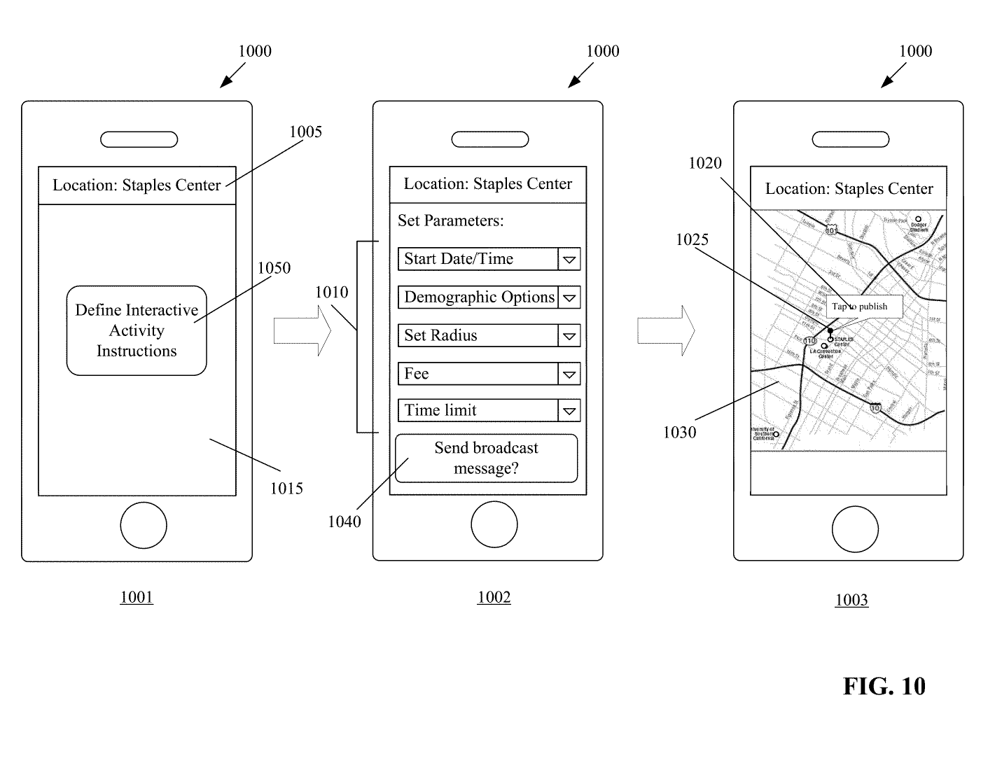

FIG. 10 illustrates an example display of a device 1000 for setting different parameters or criteria defining which users of the interactive activity service are able to access the interactive activity. Using the device 1000, a user may log into the interactive activity service using a previously created account and post interactive activities to the service using the account. However, in this example, the user may also specify criteria defining how the interactive activity is accessed, or more specifically, who can access the interactive activity and who is excluded from accessing the interactive activity.

FIG. 10 illustrates three stages 1001-1003 of a user's interaction the device 1000. The device 1000 may be communicatively connected to the interactive activity service. The device 1000 includes a display having a set of selectable criteria 1010, a location information 1005, an interactive activity visual indicator 1025, a map display 1030, a display area 1015, and UI objects 1020, 1040, and 1050.

The first stage 1001 illustrates the device 1000 displaying the interactive UI object 1050 after the device has received a user interaction to select a particular location to define an associated interactive activity. Such a selected location may be displayed as the location information 1005.

The second stage 1002 illustrates the device 1000 upon receiving an interaction from a user to post an interactive activity associated with the particular location. Such an interaction may include receiving a selection of selectable UI object 1050 in the first stage 1001. The particular location may be the location of the device or it may be a location received by user input from the user of the device. The received location may or may not be the current location of the device. In this example, the location associated with the interactive activity to be published is indicated by the location information 1005.

The second stage 1002 illustrates the device 1000 displaying different criteria 1010 to be set by receiving user interaction with the drop down objects and the UI object 1040, which when selected may cause new options to display in the display area 1015. Such options may be used for defining whether a message about when and where the interactive activity will be accessible should be provided to some or all of the users of the interactive activity service. For instance, the interactive activity service could be configured to transmit one or more messages to draw users of the interactive activity service to a particular location by enticing the users with the prospect of winning discounts or gifts. The one or more messages could include information about when and where the location based interactive activity will be available and how to access it. For example, a special access code may be required to access the location based interactive activity. If the interactive activity is going to be made available at a department store, the department store may require a behavioral action such as a purchase of a specified amount be made in order to obtain the access code. The interactive activity service may require that such behavioral actions occur during a certain time period in order to enable access.

Although this example provides several drop down options for setting the criteria, the criteria may be displayed and/or selected using any number of different display options such as text boxes for receiving user input of text, radio buttons, scrollable lists or any other suitable UI object. The criteria, in this example, may be set based on receiving a gestural interaction with the display area 1015.

The third stage 1003 illustrates the device 1000 after the interactive activity service has received instructions from the device 1000 to set the criteria specified in the display area 1015 of the second stage 1002. As shown in the third stage 1003, an interactive activity visual indicator 1025 is placed at the location on the map display 1030 that represents the location associated with the location based interactive activity. UI object 1020 provides instructions for how to publish the location based interactive activity to the interactive activity service. In this example, UI object 1020 indicates that a gestural motion such as tapping on or around the interactive activity visual indicator 1025 received at the device 1000 will cause the interactive activity to publish to the interactive activity service along with the associated criteria provided in the second stage 1002.

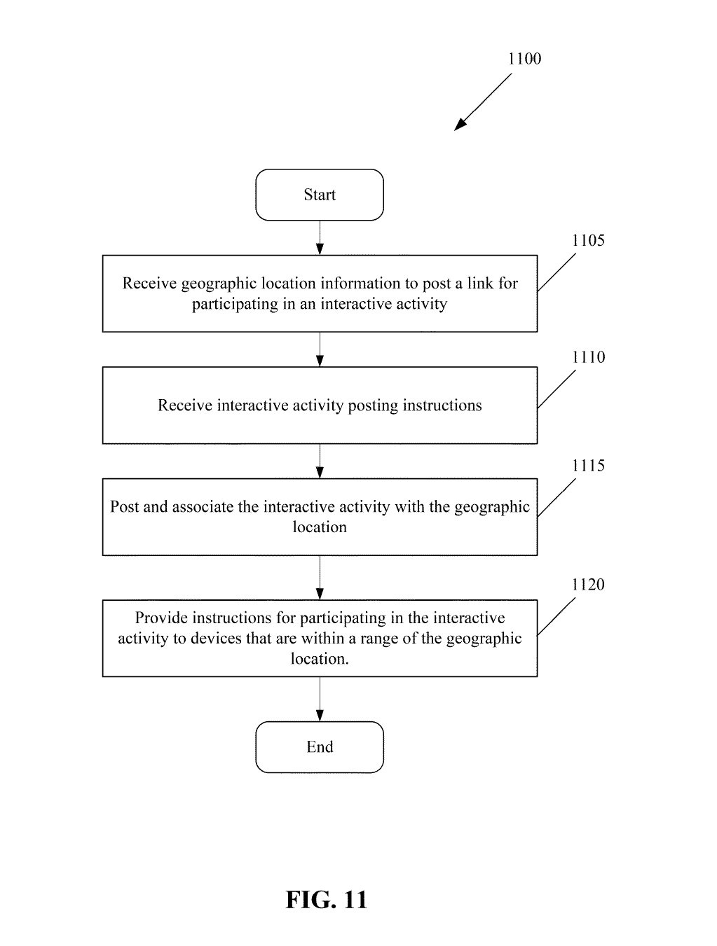

FIG. 11 conceptually illustrates a process 1100 for providing an interactive activity to the interactive activity service. The process 1100 may be performed by an interactive activity server. The process 1100 may begin after a user has logged into the interactive activity service from a device such as a mobile device or any other device capable of accessing the internet.

As shown, the process 1100 receives (at 1105) geographic location information to post a link for participating in a location based interactive activity. In some aspects of the interactive activity service, the geographic location information may be received from a device accessing the interactive activity service and is concurrently communicatively connected to a GPS service. The GPS service may provide the location information. In other aspects of the interactive activity service, the location information may be received as user input from a user inputting the location information. In such aspects, the user inputting the location information may not be physically located at the received location.

The process 1100 receives (at 1110) interactive activity posting instructions. The interactive activity may be posted to the interactive activity service. Such instructions may include a set of criteria defining how the location based interactive activity is to be accessed by different users of the service. For instance, the process 1100 may receive a geographic viewing/access radius defining that users that are within a given distance may access the interactive activity. Optionally, the process 1100 may also receive additional criteria such as the date and time that the location based interactive activity will become available and the date and/or time that the location based interactive activity will become unavailable, as well as certain behavioral actions that the device must perform before the location based interactive activity becomes available. Devices may be excluded from accessing the location interactive activity, even if they are within the geographic range, if at least one specified criteria is not met.

Additionally, the process 1100 may receive criteria for restricting location based interactive activity access such as demographic information, number of times the device may participate in the location based interactive activity, proximity to the interactive activity, time of availability, and mobile carriers for defining users that may access the location based interactive activity. By specifying different criteria, the interactive activity service may be used for targeting certain users for targeted and intelligent advertising.

The process 1100 then posts and associates (at 1115) an interactive activity with the geographic location. Once the interactive activity is posted, it may only be accessed by users or devices that satisfy the criteria discussed above when the location based interactive activity was posted to the interactive activity service. The process 1100 then provides (at 1120) instructions to for participating in the location based interactive activity to devices that are within a range of the geographic location. In some aspects of the interactive activity service, the device may display an indicator that the location based interactive activity has been posted, but the instructions for how to participate in the location based interactive activity may only be provided after the device has satisfied specified criteria and/or after the device has requested the instructions. The device may request the instructions after receiving an interaction from a user indicating that the user would like to participate in the interactive activity. After the instructions are provided, the process 1100 ends.

A second embodiment of the invention provides interactive activity service provides a crowd sourced approach to providing and consuming content in a fun, interactive social environment. Unlike the first embodiment of the invention, the second embodiment does not rely on location based services. Rather, the second embodiment relies on collecting content according to criteria such as themes and time limits. Additionally, communication between devices participating in the crowd sourced interactive activity may communicate with Interactive Activity Service 330 described with respect to FIG. 3 and in a similar manner, by communicating with the interactive activity server 330 over the internet 340. In some aspects of the interactive activity service, a crowd sourced interactive activity may be referred to as a flow or a theme. A flow describes the flow of content as it is being provided by multiple users who are directly or indirectly connected in a crowd sourced environment. Typically the flow is related to a particular theme that is originated by a first device communicatively connected to the interactive activity service.

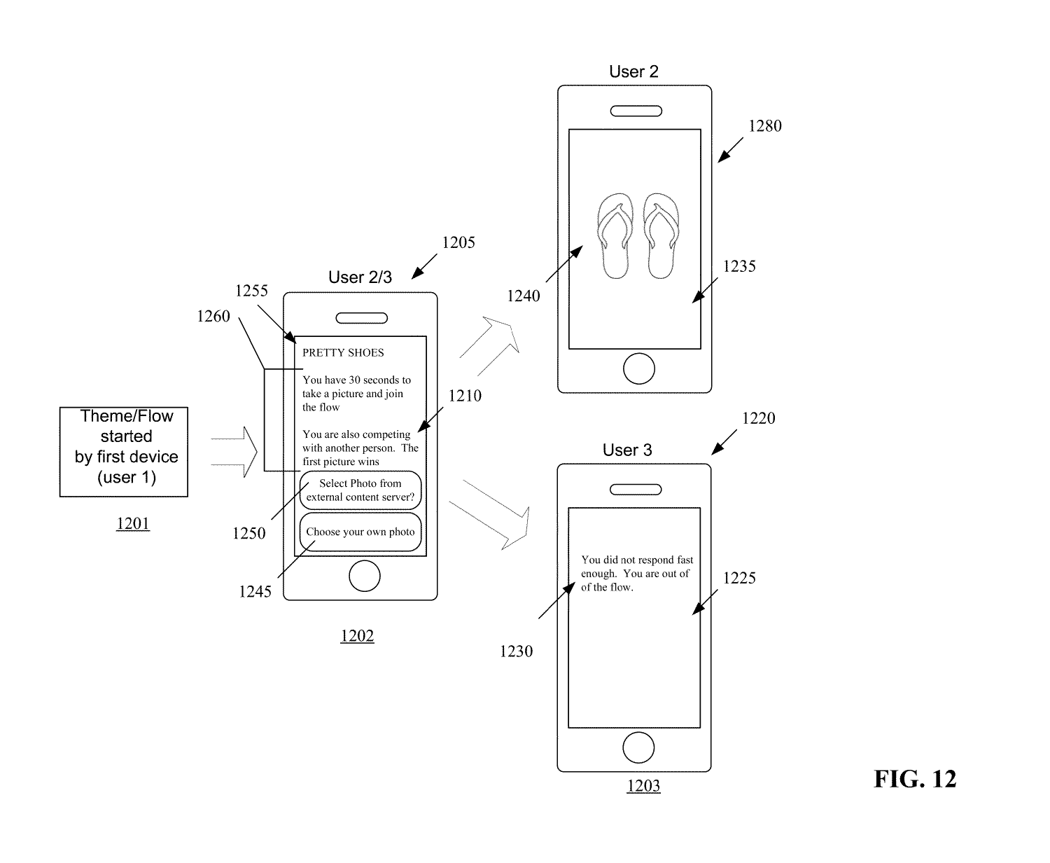

FIG. 12 illustrates several users' interactions with several devices that are participating in the second embodiment of the interactive activity service. FIG. 12 illustrates the user's interaction in three stages 1201-1203.

In the first state 1201, a theme or flow has been started by a first device. In some aspects of the service, the theme may be started by providing text of a theme that will start a competition in the crowd sourced interactive activity service. Such a competition may be in the form of a flow as discussed above where users compete to be the first to add to the flow by posting media associated with the theme. Typically users are invited to participate in the flow each time the crowd sourced interactive activity service receives a new media post to the flow.

In the second state 1202, a device 1205 is illustrated. The device 1202 includes a display area 1210, a theme 1255, instructions 1260, and selectable UI objects 1250 and 1265. The device 1265 illustrates a display that may be displayed on an exemplary device associated with a user that has been selected to participate in the flow.

As shown, display area 1210 includes the theme 1255. The theme indicates the type of media that is to be provided by the user devices that have been invited to participate in the interactive flow. The display area 1210 also includes the instructions 1260. The instructions 1260 may include information about how to participate in the flow, who is competing in the flow, and a time limit for providing content to the interactive media service to continue the flow. If content is not provided in time, the flow may end.

Display area 1210 also includes the selectable UI objects 1250 and 1245. The selectable UI objects enable the user of the device to select content from device memory or by accessing an external content providing service. Such a service may be accessed by communicating through the external services application programming interface (API). In some aspects of the service, a device may also collect the media on the fly and transmit the media content to the crowd sourced interactive activity service. For instance, the device 1205 may capture a new image to be used for continuing the flow of the crowd sourced interactive activity service.

In this example, two users have been selected to participate in the flow. Device 1205 represents an exemplary display that may be shown on all devices associated with users that have been selected to participate in the flow. The third stage 1203 illustrates devices 1210 and 1280. Both of the devices 1210 and 1280, associated with users 2 and 3, respectively, have been selected to participate in the flow. Device 1280 includes a display area 1235 and a media content 1240. Device 1220 includes a display area 1225 and text 1230. As shown by the third stage, Device 1280 provided the media content to the interactive activity service to continue the flow before device 1220. Therefore, the text 1230 on device 1220 displays a message indicating that the device 1220 has been removed from the flow for not providing a content fast enough. As discussed in detail in the foregoing, it may be possible for device 1220 to re-enter the flow by either being re-invited to participate in a subsequent round of the flow or by buying into the flow with points. The third state 1203 also illustrates that device 1280 has provided the media content 1240 associated with the theme first and may continue the flow by selecting new participants to engage in the same activity. Continuing the flow will also be described in greater detail in the foregoing.

The flow described in FIG. 12 provides a mechanism for consuming content within a service and provides the ability to socialize and meet new users around the world in a fun and interactive way. It also provides a way to provide content and make it available for users to view in an organized and interactive environment.

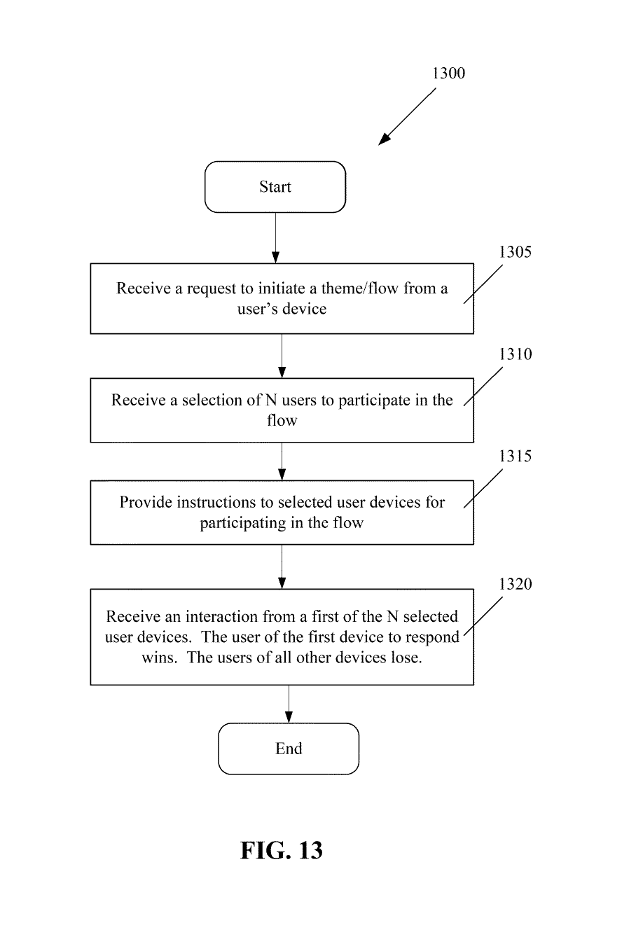

FIG. 13 conceptually illustrates a process 1300 for performing a crowd sourced interactive activity according to a second embodiment of the interactive activity service. The process 1300 may be performed by an interactive activity server. The process 1300 may begin after a user's device has logged onto or initialized a mobile application that provides the interactive activity service.

As shown, the process 1300 receives (at 1300) a request to initiate a theme or flow from a user's device. The process 1300 receives (at 1305) a selection of N users to participate in the flow. In some aspects of the process, the N users may be selected from a contacts stored on a user device's contact list and/or from contacts acquired through other third party services such as social media services (e.g., Facebook®). The process provides (at 1315) instructions to the selected user devices for participating in the flow. Such instructions may be similar to those illustrated by instructions 1260 in FIG. 1. The process receives (at 1320) an interaction from a first user of the N selected user devices. As illustrated in FIG. 1 the first device to transmit media related to the flow wins the current round and may then continue the flow. All of the other users who did not transmit related media (e.g., were not the first to respond) lose the current round and are excluded from the flow. However, as will be discussed in the foregoing, users who were previously excluded from the flow may re-enter the flow in a later round. After the media related to the flow theme is received, the round is complete and the process 1300 ends.

Devices of the second embodiment of the interactive activity service may participate by different mechanisms. For instance, a user may interact with a device using the crowd sourced interactive activity service as a spectator who views the flows and interacts with the flow or media posted to the flow by voting on the media and/or commenting on the media and/or flow. Users may also interact with a device communicatively coupled to the crowd sourced interactive activity service in order to move from being a spectator of the crowd sourced interactive activity to becoming a participant in the service. User devices may move in and out of the participant and spectator role based on the users' interaction with the service.

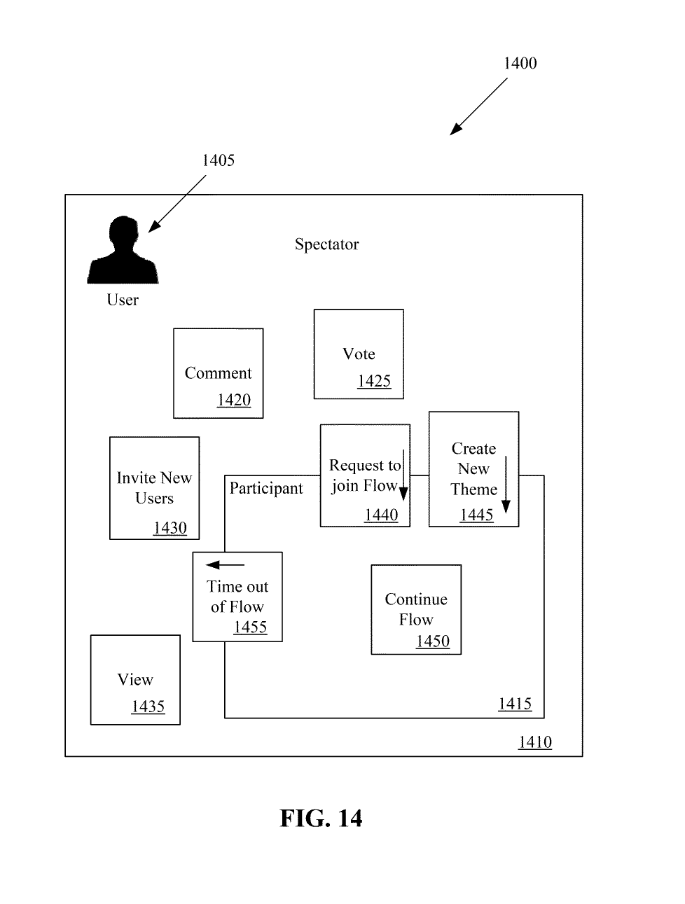

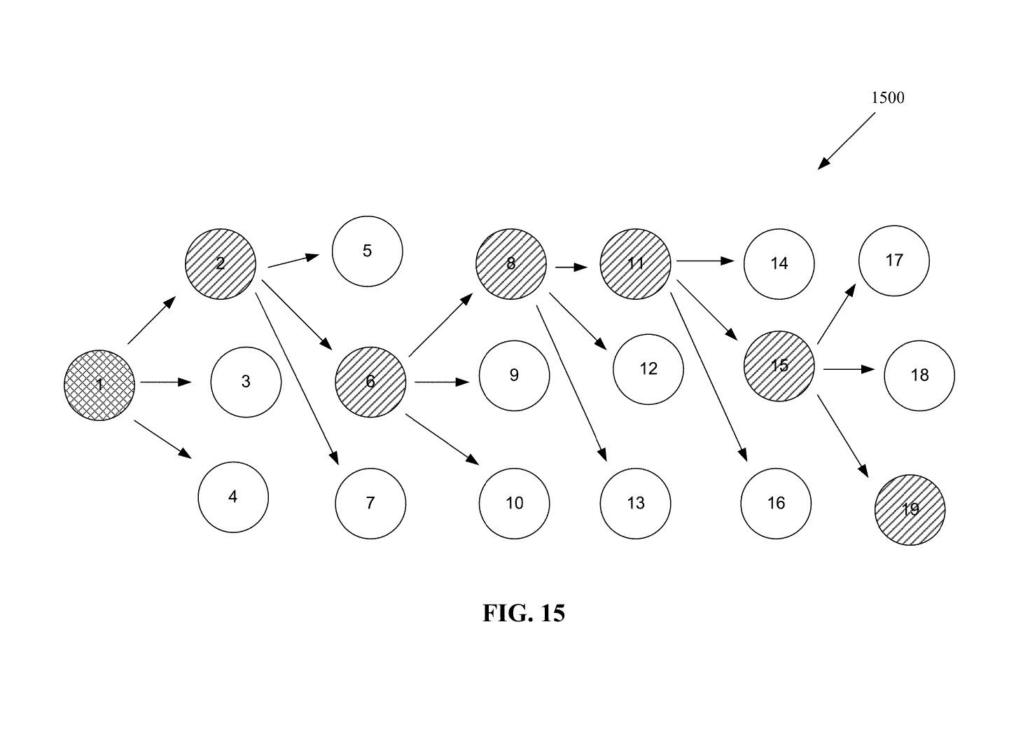

FIG. 14 illustrates an exemplary diagram 1400 of a user device's capabilities within the crowd sourced interactive activity service. For instance, a user 1405 may have at least some of the spectator capabilities listed in spectator listing 1410. Such capabilities may include voting capability 1425, commenting capability 1420, inviting new users to join the interactive activity service capability 1430, and viewing content and/or flows capability 1435. Users may transfer from the spectator role 1430 to the participant role 1415 by creating a new theme 1445, which would initiate a new flow and by requesting to join an already existing flow 1440. A user remains a participant as long as the flow continues 1450 with his/her inclusion. A user transitions from the participant role 1415 to spectator role 1410 when the user times out of the flow 1435. Such a time out may occur if the theme ends due to a lack of response in a given time period or when the user does not continue the flow by being the first to provide media content to the crowd sourced interactive activity before another device. As shown by diagram 1400 all users that enter the participant role 1415 may still partake in the spectator role 1410 simultaneously.

FIG. 15 illustrates several rounds of an exemplary flow 1500 as discussed above. The flow 1500 begins when a user's device, in this case user 1's device initiates a theme and selects three new user devices to participate in the flow. As discussed above, the selection of participants is not limited to three participants and may be any number of participants 1-N. The device may also initiate a time limit for responding to the newly created theme and/or flow. If none of the selected user devices provide media to the interactive media service in response to the new theme, the flow would end.

As shown in this example user 2's device provided media content associated with the flow's theme and has selected 3 more users to participate in the flow. In some aspects of the flow, the newly selected users may include some of the same users from the previous round or all new users. Also, as discussed above, the users may be selected from a list of users stored on the device (e.g., contact list) or from other sources such as social media sources.

In this example, the user 6's device posts the content associated with the theme before users 5 and 7. User 6 then selects 3 more users to participate in the flow. In the next round user 8's device is the first device to respond to the theme request. The flow 1500 continues through several more rounds where user devices 11, 15, and 19 win the next three rounds.

Although FIG. 15 illustrates that the flow ends after user 19's device wins the round, the flow may continue. However, user 19's device may send instructions to end the flow, or may select N new users to participate in the flow who do not respond within the set timeout. In such cases, the flow would also end. The concept described in FIG. 15 provides a mechanism for user's of a service who are unknown to each other to make connections by playing a fun and interactive game, while also providing content to the interactive activity service which can be used to generate analytics and any other suitable information.

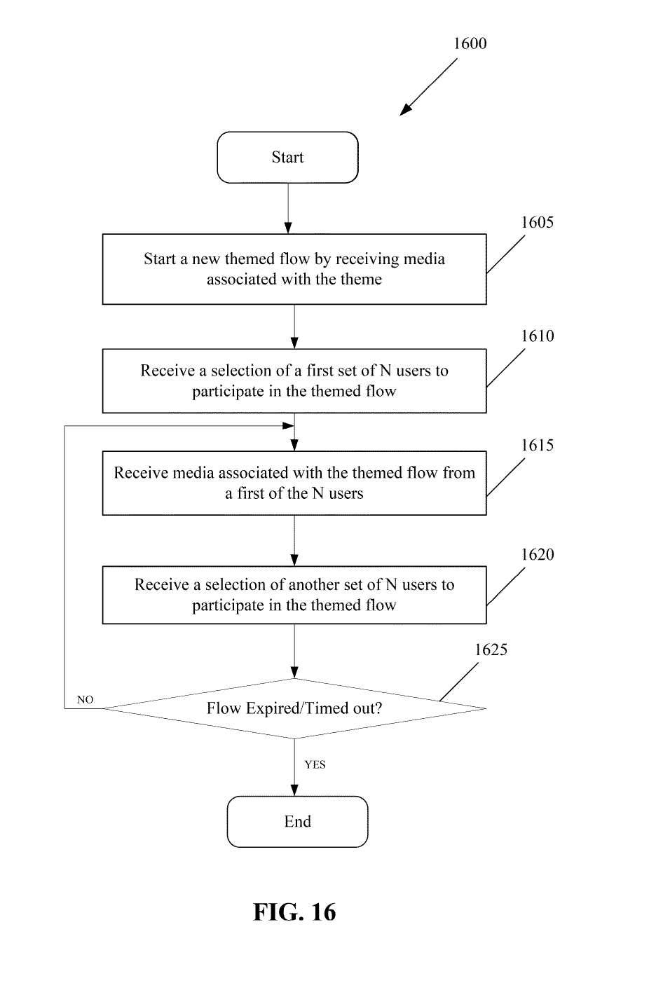

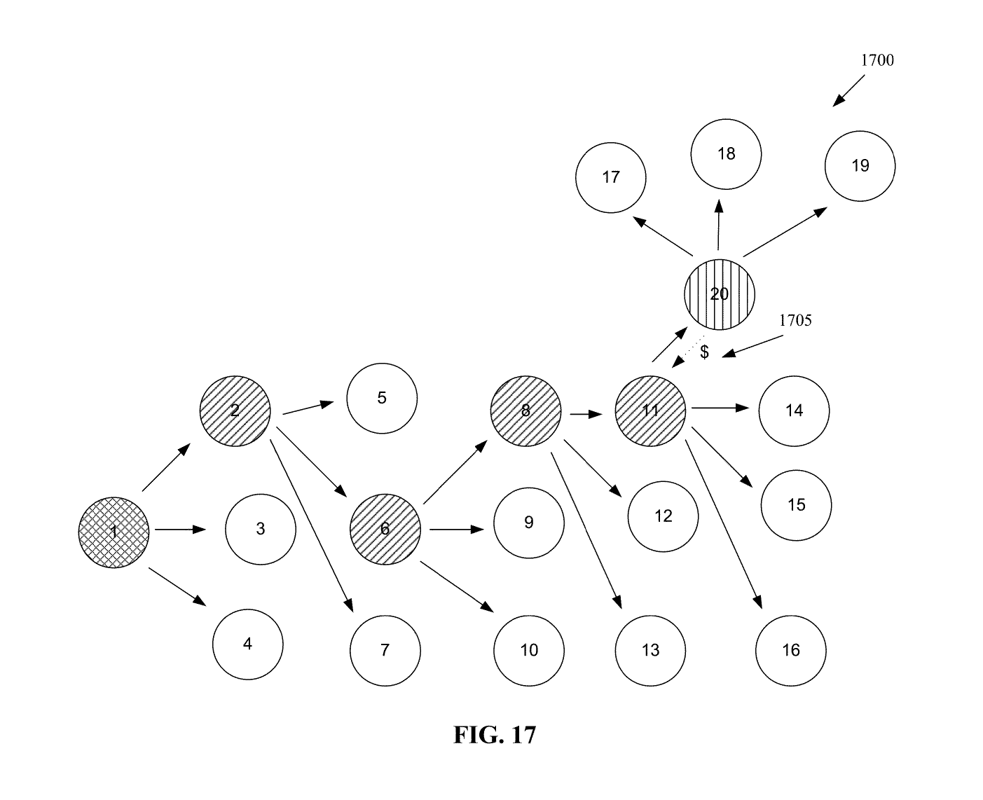

FIG. 16 conceptually illustrates a process 1600 for performing a crowd source interactive activity according to the second embodiment of the interactive activity service. The process 1600 may be performed by an interactive activity server such as server 330 discussed in FIG. 3. The process 1600 may begin after a user's device has logged onto or initialized a mobile application that provides the interactive activity service.

As shown, the process 1600 starts (at 1605) a new themed flow by receiving media associated with the theme. In some aspects of the process, the media may be an image, a video, text, music, or any other audio and/or visual media. The process 1600 receives (at 1610) a selection of a first set of N users to participate in the themed flow. The N users may be any number of users from 1 to N, where N is a number set based on the capability of the interactive activity service. For instance, the interactive activity service may have certain hardware and/or software limitations that limit the maximum amount of users. Or in some instances, the number N may be limited to a number that is most manageable to the users of the interactive activity service. In one example, the number N may be any number from 1 to 3. At this point the process 1600 may also receive a timeout indicating that the flow will complete if a response is not received before the timeout.

The process 1600 receives (at 1615) media associated with the themed flow from a first one of the N selected user devices. In some instances of the interactive activity service, the received media is associated with the theme started at 1615. Additionally, in some aspects of the interactive activity service, when the interactive activity services receives media that is not associated with the themed flow, the user who started the flow may reject the received media by interacting with the starting user's device.

In some aspects of the interactive activity service, the media received at 1615 may be an image stored on the submitting device, or the device may connect to an external media service to select a media to provide to the interactive media service. Once the media is received from the device of the first of the N users, the process 1600 receives (at 1620) a selection of another set of N users to participate in the themed flow. The process 1600 then determines (at 1625) whether the flow has timed. In some aspects of the process 1600, this determination may also be made before the media is received at 1615.

When the flow has timed out, the process ends. When the flow has not timed out, the flow will continue by returning to 1615 to receive a selection of another N user to participate in the flow. In each iteration, the N users may include some of the same users selected in any of the previous flows, or may be different users every time. Specifically, the users selected in each iteration of the interactive activity flow do not need to be mutually exclusive.

FIG. 17 illustrates an exemplary flow 1700 similar to that of FIG. 15. However, FIG. 17 differs from FIG. 15 because it illustrates a user device that would like to join or re-join the flow. In some aspects of the interactive activity service, a user's device may request entry into a flow by providing points acquired through interacting in different ways with the interactive activity service. Additionally, user devices may be provided with a buy-in option for acquiring points to be used to join the flow 1700.

As shown, at connection 1705, user device 20 has requested to join the flow by providing the requisite requirements to enter the flow. Once the interactive activity service determines that user 20's device can enter the flow, user 20's device is granted entry and included in the next round of the flow as shown in flow 1700. In this example, user 20's device was the first to post relevant media to the flow, so user 20 has selected 3 new users to participate in the next round of the flow.

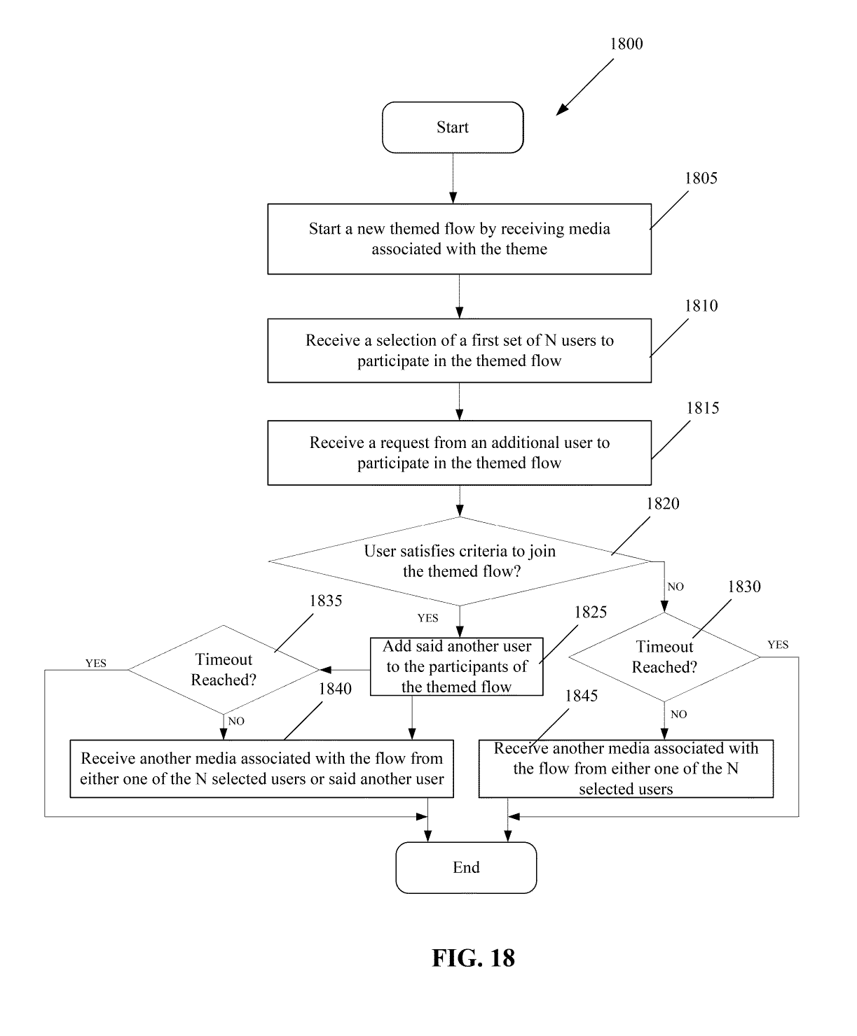

FIG. 18 conceptually illustrates a process 1800 for performing a crowd sourced flow of the second embodiment of the interactive activity service that enables a previously excluded user device to re-enter the flow. The process 1800 may be performed by an interactive activity server such as server 330 described with respect to FIG. 3. The process 1800 may begin after a user's device has logged onto or initialized a mobile application that provides the interactive activity service.

As show, the process 1800 starts (at 1805) a new flow or theme by receiving media associated with the theme. In some aspects of the process 1800 the media may simply be text media indicating the desired theme. Alternatively or conjunctively, the process 1800 may receive media such as a photo, video, audio clip, or some combination thereof, including text.

The process receives (at 1810) a selection of a first set of N users to participate in the flow. As discussed above, the N users may be selected from a number of different resources available to the user's device. The process receives (at 1815) a request from an additional user to participate in the flow. The process 1800 determines (at 1820) whether the user satisfies criteria specified to join the flow. Such criteria may include financial compensation, points acquired through participation in the interactive activity service, and/or points acquired through an external service. When the process 1800 determines (at 1835) that the user satisfies the criteria to enter the flow, the user's device is added as a participant to the flow. The process then determines (at 1835) whether the timeout for contributing to the flow has been reached. When the timeout has been reached, the process 1800 ends. When the process 1800 determines that the timeout has not been reached the process receives (at 1840) another media associated with the flow from either one of the N selected users or from the added user. As discussed above, the media may be received from the user's device or from an external source accessible to the device. The process 1800 then ends. Although the process ends, the flow may continue by repeating the process 1800 in any number of different rounds.

Referring back to 1820, when the process determines that the additional user does not satisfy the required criteria to join the flow, the process 1800 determines (at 1830) whether the timeout for responding to the flow has been reached. If the flow has timed out, the process 1800 ends. When the process 1800 determines (at 1830) that the timeout has not been reached, the process 1800 receives (at 1845) another media associated with the flow from either one of the N selected users. The process 1800 then ends. As shown by FIG. 18 it is possible for user devices that do not provide media in time to re-join the flow using the process already described.

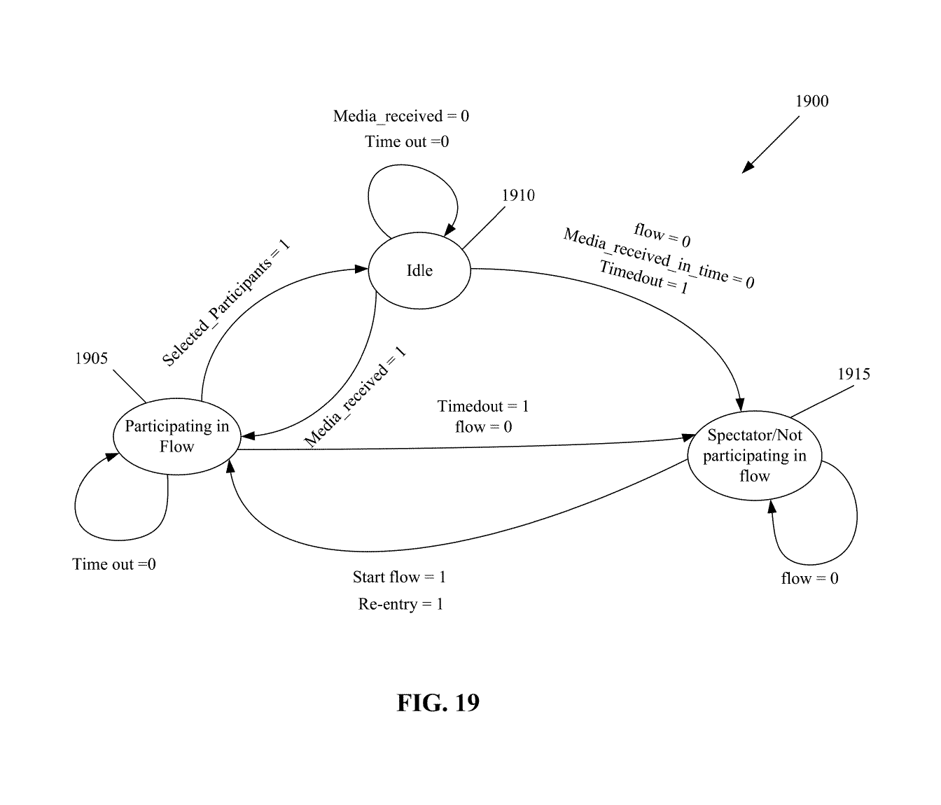

FIG. 19 illustrates an exemplary state diagram 1900 associated with the second embodiment of the interactive activity service. The state diagram 1900 may be associated with an exemplary flow and run utilized by a processor of the interactive activity server 330. As shown, 1900 illustrates three states 1905-1915.

As shown, state 1905 indicates participation in a flow. When media is received before any timeout is reached, the flow may continue. Thus, while the timeout=0 (Boolean False), the service remains in state 1905. When participants are selected to participate in the flow, so that the flow can grow or start a new round, specifically, when selected_participants=1 (True), the service is transitions to an idle state 1910. However, if the flow variable=0 or the timeout variable transitions to 1, the service transitions to the nonparticipant state 1915.

The service remains in an idle state 1910 while timeout=0 and while media_received=0. When media associated with the flow is received, the media_received variable switches to 1, indicating True and the service transitions back to the flow participation state 1905. However, if the timeout variable flips to 1 before media_received flips to 1, then the service transitions to a non-participant state 1915. Additionally, if the flow has ended (flow=0), the service transitions to the non-participant state 1915. While the flow variable remains false, the service remains in the non-participant state 1915. However, if a reentry request to a flow is received (e.g. re_entry=1) or a initiation flow request is received (e.g., start_flow=1), then the service transitions back to the flow participant state 1905. FIG. 19 provides a high level exemplary overview of some of the states that may be part of the second embodiment of the interactive activity service. However, it is possible that different states beyond the ones illustrated in FIG. 19 may be possible.

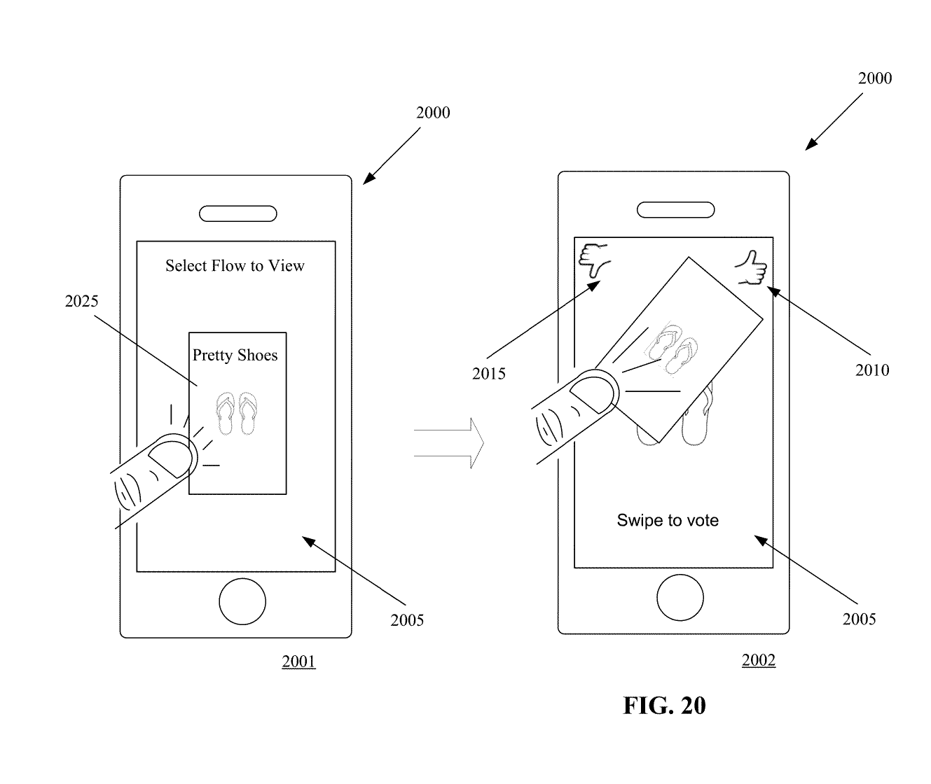

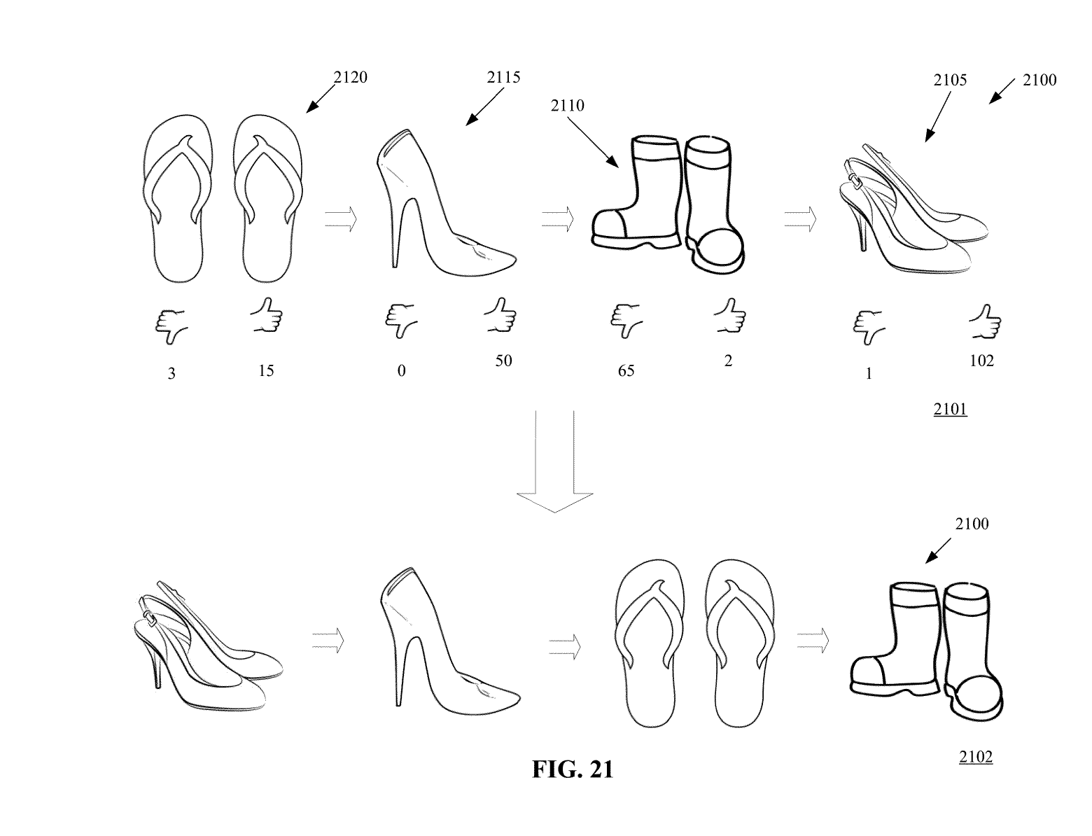

FIG. 20 illustrates an exemplary user's interaction with a crowd sourced interactive activity on a device by performing spectator interactions with the interactive activity service. As discussed above, a user may enter the spectator role when the user is not engaged in a flow. FIG. 20 includes a device 2000 which may be communicatively connected to the interactive activity service by either logging into the interactive activity service or initializing a mobile application tied to the interactive activity service. Device 2000 includes a display area 2005, graphical representation 2025, visual indicators 2010 and 2015. FIG. 20 illustrates two stages 2001 and 2002 of a user's interaction with the device 2000.

In the first stage 2001 a device may show a user a flow that can be displayed for viewing. Although in this example, only one flow is illustrated, in some aspects of the device, several different flows may be available for viewing and several different graphical representations of the different flows may be visible in the device display area 2005. As shown, in the first state the device 2000 is receiving a selection of visual indicator 2025 to view the flow “Pretty Shoes.”

In the second stage 2002, the display area 2005 may display the contents of the flow to allow the user to vote on whether he/she finds the content appealing or relatable to the particular flow. The device 2000 may receive the user's vote by a gestural interaction with the media. For instance, the device may receive a gestural interaction to swipe right to up vote the media and swipe left to down vote the media. Such instructions may be made clear from visual indicators 2010 and 2015. In some aspects of the device, the device may receive a gestural interaction such as a tap of the visual indicator 2010 or 2015 to indicate his/her vote for the displayed media content. In this example, only one media content is displayed. However, in some aspects of the device, after receiving a swipe of one media content, the next media content may display in display area 2005, which enables the device to receive a vote from a user on the next media content in the flow. In other aspects of the device, the device may randomly display different content from different flows for voting by the user. In addition to voting on content, a user in spectator mode may also have the opportunity to comment on such content. In some aspects of the service, when a comment is received at the interactive activity service regarding media content that was posted by a particular user, the particular user may receive a notification that a comment has been made regarding his/her content. Additionally, participants who post media to at least one flow may have the capability of viewing how many up or down votes their content has received.

In some aspects of the service, a flow may be reorganized based on the votes received by spectators of the crowd sourced interactive activity service. FIG. 21 illustrates an exemplary reorganization of a flow 2100 based on the received up and down votes. Flow 2100 includes slingback pump 2105, rain boots 2110, stiletto heels 2115, and flip flops 2120 FIG. 21 illustrates the reorganization in two stages 2101 and 2102. As shown in the first stage 2101, the slingback pump 2105 received the most up votes followed by the stiletto heels 2110. The rain boots 2110 received the most down votes. The flip flops 2120 fall somewhere in the middle.

In the second stage 2102, the flow is reorganized based on the votes shown in the first state 2102. As shown, the slingback pump 2105 moved to the first position, the stiletto heel 2115 moved to the second position, the flip flops 2120 moved to the third position, and the rain boots 2110 moved into the last position. By reorganizing the flow, spectators are able to consume the more desirable content in an easier fashion. The crowd sourced interactive activity service may utilize any suitable means for determining the order of the media content in the flow.

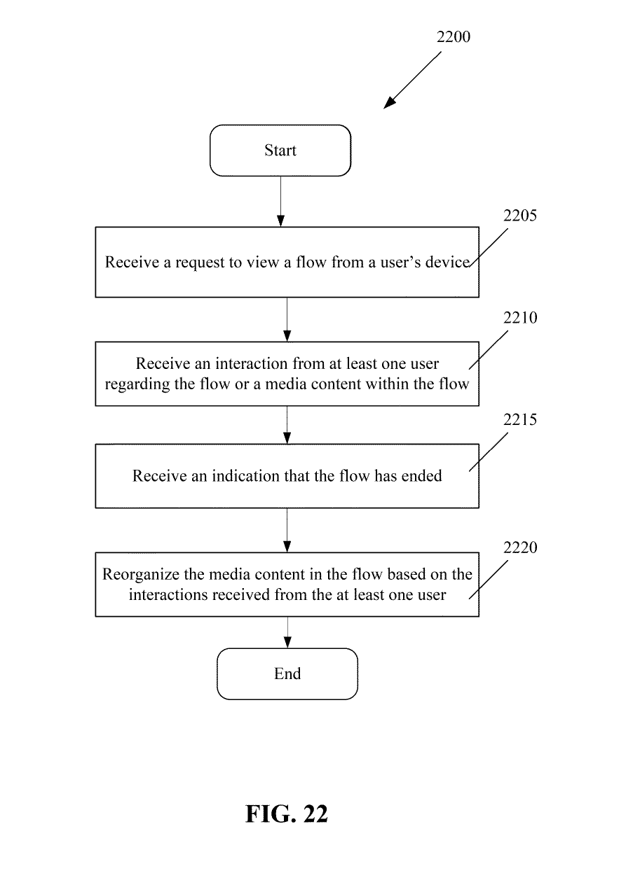

FIG. 22 conceptually illustrates a process 2200 for performing a flow reorganization as part of the second embodiment of the interactive activity service. The process 2200 may be run on an interactive activity server such as interactive activity server 303 as described in FIG. 3. The process 2200 may begin after a user's device has logged onto or initialized a mobile application that provides the interactive activity service.

As shown, the process 2200 receives (at 2205) a request to view a flow from a user's device. The process receives (at 2210) an interaction from at least one user regarding the flow or a media content within the flow. In some aspects of the interactive activity service, the interaction may include commenting, voting, sharing, or filtering the flow or media. Examples of such filtering include sorting by top trending flows/media, most active flows/media, longest running flow/media and most reported flow/media.

At 2215 the process 2200 receives an indication that the flow has ended. The process 2200 reorganizes (at 2220) the media content in the flow based on the interactions received from the at least one user of the interactive activity service.

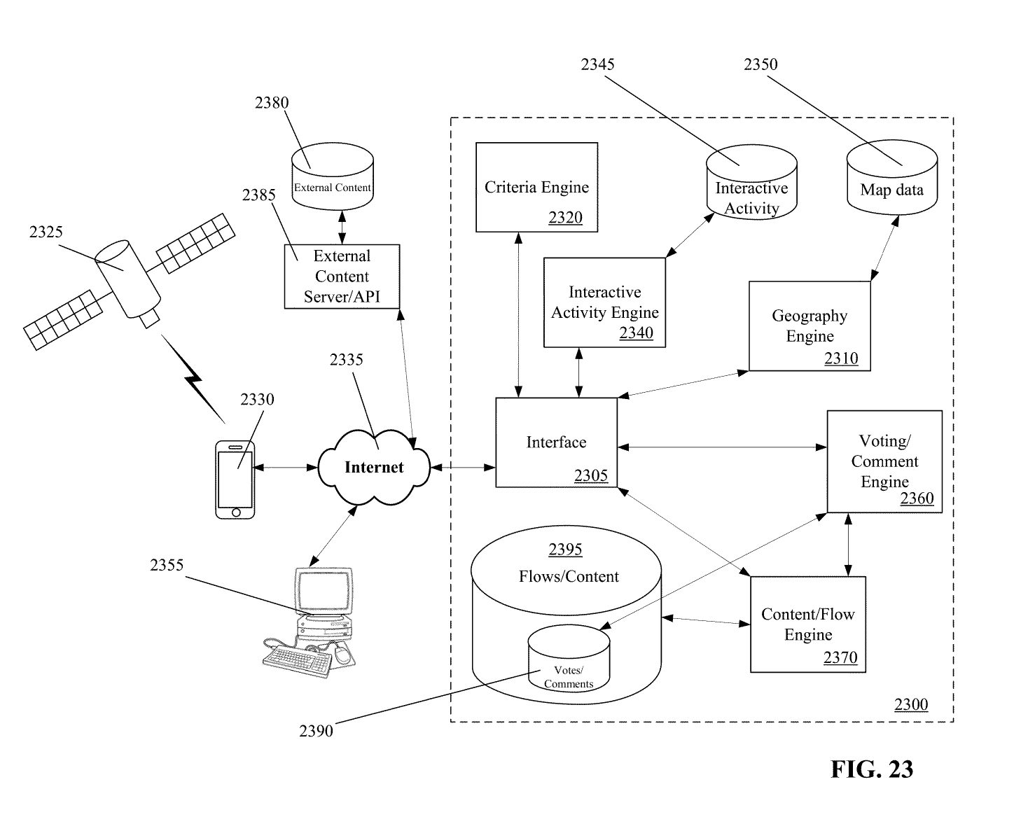

FIG. 23 illustrates an exemplary configuration of a interactive activity server 2300. The interactive activity server described in FIG. 23 includes both portions of the location based and crowd sourced interactive activity service.

As shown, the interactive activity server is communicatively coupled to devices 2330, 2355, and external content server 2385 by using the internet 2335. The device 2330 may be a mobile device such as a cellular phone or tablet. The mobile device communicates with a GPS satellite 2325. The external content server 2385 is communicatively coupled with external content that can be retrieved by the external content server and provided to the interactive activity server over the Internet.

The interactive activity server includes an interface 2305, a geography engine 2310, a map data storage 2350, a criteria engine 2320, interactive activity engine 2340, and an interactive activity information storage 2345, a voting/comment engine 2360, a content/flow engine 2370, and a flow/content database 2395. The flow/content database also includes data 2390 pertaining to the votes and/or comments received related to the media.

First, communication among the various server modules for the location based interactive activity service will be discussed. In the location based interactive activity service, the interface 2305 is communicatively coupled to the interactive activity engine 2340. The interactive activity engine 2340 stores information provided by the devices 2330 and/or 2355 or any device capable of connecting to the internet (not shown) in the interactive activity storage 2345. The interactive activity engine 2340 also retrieves interactive activity information from the interactive activity information storage 2345 when a request to access the interactive activity is received from the mobile device 2330.

The geography engine 2310 associates a geographic location with the interactive activity. The geography engine 2310 also retrieves the map data from the map data storage 2350 and provides the map data to the mobile device 2330 and/or the device 2355 through the interface 2305. The geography engine 2310 may receive a geographic location from the mobile device 2330 and/or the device 2355 (through the interface 2305). The mobile device 2330 may be capable of communicating with the GPS satellite 2325 to receive the location information. However, the location information for either the mobile device 2330 or the device 2355 may be acquired through other means such as user input of a location or receiving a location obtained through other services capable of providing a location such as a telecommunications provider or internet service provider.

The criteria engine 2320 associates a set of criteria with interactive activities to define how the interactivity activities are accessed (or not accessed). The criteria engine 2320 receives the criteria from the mobile device 2330 and or the device 2355, which communicates through the interface 2305. Optionally, the interactive activity server 2300 may include a cost/pricing engine, which associates a cost with a geographic location and criteria, such as time and duration for accessing the interactive activity. The cost/pricing information may provide the cost/pricing information to the mobile device 2330 and/or 2355 by communication through the interface 2305. The cost/pricing engine may be responsible for providing a pricing structure for posting and/or providing interactive activities to mobile devices of the interactive activity service. The functionality of the cost/pricing engine has been discussed in detail with respect to FIG. 10.

Second, communication among the various server modules for the crowd source based interactive activity service will be discussed. In the crowd source based interactive activity service, the interface 2305 also communicates with the devices 2330 and 2355. The interface 2305 may receive instructions to start a flow or add media to a flow by communicating such instructions over the internet 2335 to the interface 2305. The interface 2305 may forward those instructions to the content/flow engine 2370. The content/flow engine 2395 is communicatively coupled with the flow/content storage. When a new flow is started or media is added to the flow, the content/flow engine 2370 may add the new media to the flow/content storage 2395. Additionally, the content/flow engine 2370 may be responsible for verifying that a timeout has not occurred. The content/flow engine 2370 may use information related to time out information received from either of the devices 2330 and 2355 and compare that information with the internal clock of the interactive activity server 2300.

The above description primarily relates to how the interactive activity server performs when content is being communicated by a device using participant mode. In spectator mode, the devices 2330 or 2355 may request to view flow or content from the interactive activity server 2300. Such a request would reach the interface 2305 by transmission over the internet 2335. The interface 2305 would forward the request to the content/flow engine 2370 to retrieve the content or flow information from the flows/content storage 2395. The retrieved content or flow would be transmitted back to the device 2330 or 2355 from the server 2300 over the internet 2335. Additionally, one of the devices 2330 or 2355 may send instructions to vote or comment on the received content and/or flow. Such instructions would be transmitted to the interface 2305 and forwarded to the voting/commenting engine. The voting/commenting engine 2360 is communicatively coupled to the content/flow engine 2370 and the votes/comments storage 2390 within the flows/content storage 2395. The voting/comment engine 2360 communicates with the content/flow engine 2370 to link the comments and votes to a particular flow and stores the associated votes and comments in the votes/comments portion 2390 of the flows/content storage 2395. When the device 2330 or 2355 transmits instructions to view the comments or votes associated with a particular flow or content, the instructions are received at the interface 2305 and processed by the voting/comment engine 2360 and content/flow engine 2370 to retrieve the appropriate information from the flows/content storage 2395 and transmit the information back to the devices 2330 or 2355 via the interface 2305.

Many of the above-described features and applications are implemented as software processes of a computer programming product. The processes are specified as a set of instructions recorded on a machine readable storage medium (also referred to as machine readable medium). When these instructions are executed by one or more computational or processing unit(s) (e.g., one or more processors, cores of processors, or other processing units), they cause the processing unit(s) to perform the actions indicated in the instructions. Examples of machine readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

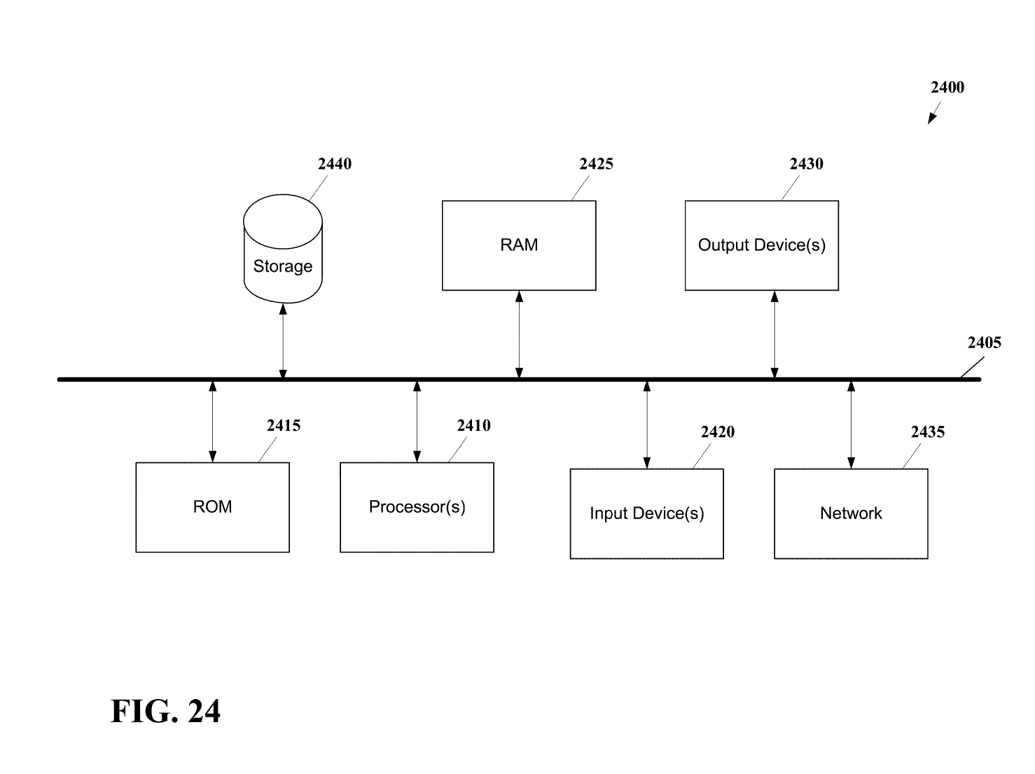

FIG. 24 illustrates an exemplary electronic system 2400 that may implement the interactive activity service. The electronic system includes various types of machine readable media and interfaces. The electronic system includes a bus 2405, processors 2410, read only memory (ROM) 2415, input device(s) 2420, random access memory 2425), output device(s) 2430, a network component 2435, and a permanent storage device 2440. The electronic system include a computer program product including the machine readable media.

The bus 2405 the communicatively connects the internal devices and/or components of the electronic system. For instance, the bus 2405 communicatively connects the processor(s) 2410 with the ROM 2415, the RAM 2425, and the permanent storage 2440. The processor(s) 2410 retrieve instructions from the memory units to execute processes of the invention.

The ROM 2415 stores static instructions needed by the processor(s) 2410 and other components of the electronic system. The ROM may store the instructions necessary for the processor to execute the web server, web application, or other web services. The permanent storage 2440 is a non-volatile memory that stores instructions and data when the electronic system 2400 is on or off. The permanent storage 2440 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 2425 is a volatile read/write memory. The RAM 2425 stores instructions needed by the processor(s) 2410 at runtime. The bus 2405 also connects input and output devices 2420 and 2430. The input devices enable the user to communicate information and select commands to the computer system. The input devices 2420 may be a keyboard or a pointing device such as a mouse. The input devices 2420 may also be a touch screen display capable of receiving touch interactions. The output device(s) 2430 display images generated by the computer system. The output devices may include printers or display devices such as monitors.

The bus 2405 also couples the electronic system to a network 2435. The electronic system may be part of a local area network (LAN), a wide area network (WAN), the Internet, or an Intranet by using a network interface. The web service may be provided to the user through a web client, which receives information transmitted on the network 2435 by the electronic system 100.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for” or, in the case of a method claim, the element is recited using the phrase “step for.”

What is claimed is:

1. A method comprising:
receiving a first location associated with a mobile device;
determining that the first location is within a range of a second location associated with associated with an activity; and
providing instructions for participating in the activity to the device.

2. The method of claim 1, wherein the instructions comprise text information instructing a user to perform at least one action at the second location.

3. The method of claim 1, wherein the instructions comprise waiting for a preselected interaction with the device.

4. The method of claim 1, wherein the instructions comprise receiving at least one of text, graphical, audio, and multimedia content.

5. The method of claim 1, wherein the range is a predefined radial distance from the second location.

6. The method of claim 1, further comprising:
receiving an interaction from a user based on the provided instructions;
determining that the device is still within the range of the second location; and
providing new instructions to the device based on the user interaction.

7. The method of claim 1, further comprising:
maintaining at least one criteria associated with the instructions, wherein providing the instructions to the device comprises providing the instructions when the at least one criteria is satisfied by the device.

8. The method of claim 1, further comprising receiving a scan of a code in response to the provided instructions.

9. The method of claim 8, wherein the code is any one of a group of interactive codes comprising: a quick response (QR) code, a barcode, a 2-dimensional code, an audio code, or a visual code.

10. A computer program product comprising a machine-readable medium comprising instructions executable to:
receive a first location associated with a mobile device;
determine that the first location is within a range of a second location associated with associated with an activity; and
provide data for participating in the activity to the device.

11. The computer program product of claim 10, wherein the data comprise text information instructing a user to perform at least one action at the second location.

12. The computer program product of claim 10, wherein the data comprise waiting for a preselected interaction with the device.

13. The computer program product of claim 10, wherein the data comprise receiving at least one of text, graphical, audio, and multimedia content.

14. The computer program product of claim 10, wherein the range is a predefined radial distance from the second location.

15. The computer program product of claim 10, wherein the machine-readable medium further comprises instructions executable to:
receive an interaction from a user based on the provided data;
determine that the device is still within the range of the second location; and
provide new data to the device based on the user interaction.

16. The computer program product of claim 10, wherein the machine-readable medium further comprises instructions executable to:
maintaining at least one criteria associated with the data, wherein the instructions executable to provide the data to the device comprises instructions executable to provide the data when the at least one criteria is satisfied by the device.

17. The computer program product of claim 9, wherein the machine-readable medium further comprises instructions executable to receive a scan of a code in response to the provided data.

18. The computer program product of claim 17, wherein the code is a quick response (QR) code or a barcode.

19. A system comprising:
at least one processor configured to:
receive a first location associated with a mobile device;
determine that the first location is within a range of a second location associated with associated with an activity; and
provide instructions for participating in the activity to the device.

20. The system of claim 18, wherein the instructions comprise text information instructing a user to perform at least one action at the second location.

21. The system of claim 18, wherein the instructions comprise waiting for a preselected interaction with the device.

22. The system of claim 18, wherein the instructions comprise receiving at least one of text, graphical, audio, and multimedia content.

23. The system of claim 18, wherein the range is a predefined radial distance from the second location.

24. The system of claim 21, wherein the processor is further configured to:
receive an interaction from a user based on the provided instructions;
determine that the device is still within the range of the second location; and
provide new instructions to the device based on the user interaction.

25. The system of claim 19, wherein the processor is further configured to:
maintaining at least one criteria associated with the instructions, wherein providing the instructions to the device comprises providing the instructions when the at least one criteria is satisfied by the device.

26. The system of claim 19, wherein the processor is further configured to receive a scan of a code in response to the provided instructions.

27. The system of claim 26, wherein the code is a quick response (QR) code or a barcode.

28. A method comprising:
generating a themed flow;
receiving a plurality of users to include in the flow; and
receiving a content from a device of a particular one of the plurality users associated with the flow, wherein upon receiving the content, the users from which content was not received are removed from the flow.

29. The method of claim 28, wherein the plurality of users is a first plurality of users, wherein the particular user selects a second plurality of users to include in the flow.

30. The method of claim 28, further comprising receiving a request to include one of the removed users back in the flow.

31. The method of claim 30, further comprising receiving information associated with the user to verify that the user is capable of being included in the flow again.

32. The method of claim 28, wherein the content is received by retrieving the content from the particular user's device.

33. The method of claim 28, wherein the content is received by accessing an external content server, wherein the content is received from the third party content server.

34. The method of claim 28, further comprising receiving a request to view the flow from a device that is not associated with any of the plurality of users.

35. The method of claim 34, further comprising receiving an interaction from a user of the device not associated with the flow, the gestural interaction being one of a vote, a comment, and a request to join the flow.
